(19) United States
(12) Patent Application Publication
(10) Pub. No.: US 2026/0234327 A1
(43) Pub. Date: Aug. 13, 2026

(54) SILOXANE-FUNCTIONAL COMPOUNDS, THEIR PRODUCTION, AND THEIR USE IN POLYURETHANE FOAMS

(71) Applicant: Evonik Operations GmbH, Essen (DE)

(72) Inventors: Felix Mühlhaus, Essen (DE); Michael Ferenz, Essen (DE); Eva Emmrich-Smolczyk, Essen (DE); Sarah Otto, Essen (DE)

(73) Assignee: Evonik Operations GmbH, Essen (DE)

(21) Appl. No.: 19/471,095

(22) PCT Filed: Mar. 27, 2024
(86) PCT No.: PCT/EP2024/058177

§ 371 Date: Sep. 30, 2025

(30) Foreign Application Priority Data
Apr. 6, 2023 (EP) 23166920.1

(51) Int. Cl. C08G 65/336; C08J 9/00; C08L 75/08

(52) U.S. Cl. CPC C08G 65/336; C08J 9/0061; C08L 75/08; C08J 2371/02; C08J 2375/08; C08L 2203/14

(57) ABSTRACT

The present disclosure relates to polyurethane foams and surface-active foam stabilizers added thereto. In particular, the present invention relates to polyurethane foams employing siloxane-functional compounds, which are characterized by exceptionally low volatile organic compound emissions and provide foams with excellent physical properties, whereby the siloxane-functional compound comprises at least two trisiloxane units bound to a polyether-functional backbone. Also provided are methods for producing the siloxane-functional compounds as well as uses in the preparation of polyurethane foams.

### TECHNICAL FIELD

The present invention relates to siloxane-functional compounds, compositions comprising the same, and their use in the production of polyurethane foams, related methods and polyurethane foams and articles comprising the same. The siloxane-functional compounds as additives may inter alia provide for polyurethane foams with exceptionally low volatile organic compounds emissions and excellent physical properties.

### TECHNICAL BACKGROUND

Polyurethane foams are typically produced by reacting organic polyisocyanates with compounds containing two or more active hydrogen-containing groups, in particular polyols, in the presence of blowing agents, and optionally further additives such as surfactants, foam stabilizers, catalyst(s), etc.

Two major reactions are promoted by the catalysts among the reactants during the preparation of polyurethane foam, polymerization and blowing. These reactions must proceed simultaneously and at a competitively balanced rate during the process in order to yield polyurethane foams with desired physical properties.

Owing to their physical properties, polyurethane foams are used in a very wide range of applications. A particularly important market for various types of polyurethane foams is the automotive industry. Polyurethane foams are typically used in motor vehicles for example as roof linings, for interior cladding of the doors, for punched-out sun visors, for steering wheels, and for seat systems.

In the production of polyurethane foams often additives such as one or more siloxanes with surface-active properties are employed. Such siloxanes are characterized by a wide variety of structural properties, because the tasks of the siloxanes in foaming can differ largely. For example, shrinking of the foams should be avoided. On the other hand, a sufficient cell opening is intended when the foam has reached its maximum expansion, which also positively influences the tendency of shrinking of the foam. In addition, the mixture to be foamed often must cover complicated flow paths, especially in the case of moulded foams, and should not have any defects in the foam structure after foaming is complete. To this end, the distribution and flow properties of the foam must be optimized.

One option for providing foam compositions with good flow characteristics is to utilize relatively short-chain linear siloxanes having less than 15 repeating units as surface-active foam stabilizer. However, a problem frequently occurring with the use of such surface-active foam stabilizers is that unreacted low molecular weight stabilizers are volatile and can cause undesirable emissions from the polyurethane foam that subsequently deposit on, for example, the car windows, as an oily film. Additionally, in recent years the requirements set by the automotive manufacturers for their foam suppliers have become substantially more stringent, especially with regard to emission specifications. Whereas in the past attention was focused only on the fogging behaviour of the foams (e.g., DIN 75 201 for the determination of the fogging behaviour of materials for interior automotive trim), today the content of volatile organic compounds (VOC) is also a subject of analytical determinations (e.g., Volkswagen central standard 55 031, Daimler Chrysler PB VWT 709 as well as VDA 276 and 278). Therefore, it is a desire to provide foam stabilizers which minimize or even avoid these emissions in order to meet the stringent provisions of the automobile manufacturers.

Different siloxane-group containing surface-active foam stabilizer are known in the literature. For example, EP 1 095 968 A1 describes the production of cold cure foams using polydimethylsiloxanes which have a particularly narrow chain length distribution and consist of more than 90% of siloxanes with the chain lengths N=7-9. These siloxanes do not take part in the polymerization reaction and their surfactant properties are therefore retained until the end of foaming. However, by using such rather volatile polydimethylsiloxanes, the problem may arise that these substances later emit from the foam, which is undesirable especially in automotive applications.

In US 2007/0072951, siloxanes comprising one siloxane unit and at least one silanol functionality and their use as a surfactant in the production of polyurethane cold cure foams are described. Most of the silanol-functionalized siloxanes, however, result in closed-cell foams, which are prone to shrinkage.

Further, DE 32 34 462 C1 describes a process for the preparation of highly elastic cold cure polyurethane foams using polyether-modified siloxanes containing a siloxane block comprising 4 to 25 silicon atoms and 1.5 to 10 polyether blocks bound to the siloxane block. The polyether units comprise oxyethylene (EO) and oxypropylene (PO) units. No polyether-modified siloxanes containing less than 1.5 blocks per molecule are described. Such polyether siloxanes have the disadvantage that they provide a narrow processing window and, in the case of MDI cold foams, can easily result in excessively stabilized or closed-cell foams that tend to shrink.

WO 2010/081601 A1 describes the preparation of polyurethane cold foams using linear siloxanes which comprise one siloxane unit and, in addition to the Si alkyl substitution in the chain, contain exactly one further organic modifying group bonded to a terminal silicon atom. Such siloxanes are also called alpha-siloxanes. A decisive disadvantage of alpha-siloxanes is that they are not accessible in pure form, or only with great difficulty, and that in general they always contain a proportion of non-functionalized, volatile polydimethylsiloxanes.

DE 10 2019 200 446 A1 describes polyether-modified siloxanes with one siloxane unit and at least two OH groups and a process for using them in the preparation of polyurethane foams with near-critical or supercritical fluids, preferably supercritical CO₂.

US 2019/110470 A1 describes a low foam surfactant composition comprising (a) a di-trisiloxane alkoxylate component of general formula (I) and (b) a mono-trisiloxane alkoxylate component of general formula (II). The general formula of compound (1) is (R¹R²R³SiO)₂(R⁴)Si—R⁵— Si(R⁶)(OSiR⁷R⁸R⁹), wherein R¹ to R⁴ and R⁶ to R⁹ are alkyl groups and R⁵ is a divalent polyalkyleneoxide. The di-trisiloxane alkoxylate (1) is prepared by hydrosilylation of a trisiloxane compound MD+M having one SiH group with a polyether compound end-capped at both sides by an allyl group and in the presence of a hydrosilylation platinum catalyst. D3 mentions that the trisiloxane component (I) can be used in coating such coating based on polyurethane resins. However, the document does not mention the use of the di-trisiloxane component (I) in compositions for the preparation of polyurethane foams.

Consequently, there is still a need for improved surface-active foam stabilizers that alleviate or avoid the drawbacks or shortcomings of the prior art mentioned hereinbefore. In particular, it is an object of the present invention to provide surface-active foams stabilizers that enable to form high-quality polyurethane foams that have low or no VOC emissions, are open-celled, have no or little tendency to shrink and exhibit excellent physical properties.

### SUMMARY

Surprisingly, it has been found that such objective may be achieved by a siloxane-functional compound comprising at least two trisiloxane units bound to a polyether-functional backbone, characterized in that the siloxane-functional compound is represented by Formula (1) in claim 1. The present invention also provides a siloxane composition comprising one or more of the siloxane-functional compounds of the present invention and optionally one or more further silicon-containing and/or silicon-free foam stabilizers.

The present invention is also directed to the use of such a siloxane-functional compound or compositions comprising the same as an additive in the production of polyurethane foams.

Moreover, the present invention also provides a composition for preparing a polyurethane foam, comprising
a) at least one isocyanate-reactive compound having in average at least two groups per molecule being reactive to isocyanate groups;
b) at least one polyisocyanate having in average at least two isocyanate groups per molecule;
c) at least one blowing agent;
d) at least one catalyst;
e) at least one siloxane-functional compound or a siloxane composition as described above and in more detail below.

The present invention additionally provides a method for preparing a polyurethane foam comprising (i) providing a composition comprising at least one isocyanate-reactive compound having in average at least two groups being reactive to isocyanate groups, at least one siloxane-functional compound or a siloxane composition as described above and in more detail below, at least one blowing agent, at least one catalyst, and optionally one or more further additives; (ii) contacting the composition with a polyisocyanate having in average at least two isocyanate groups per molecule or a mixture of polyisocyanates; and (iii) curing the composition under the formation of a polyurethane foam.

Moreover, the present invention is also directed towards a polyurethane foam prepared in the presence of at least one siloxane-functional compound of the present invention, for example according to the aforementioned method for preparing a polyurethane foam, as well as an article comprising a polyurethane foam as disclosed herein.

Also, the present invention relates to a method of preparing the siloxane-functional compound of the present invention. The method comprises reacting a polyether comprising at least two carbon-carbon double bonds reactive to Si—H bonds with a hydrogen siloxane in the presence of a catalyst suitable for hydrosilylation, whereby the hydrogen siloxane is a hydrogen trisiloxane, a hydrogen tetrasiloxane or a mixture thereof.

Advantageously, the siloxane-functional compounds as defined in appended claim 1 employed as an additive in compositions to produce polyurethane foams, especially moulded foams, can positively influence the processing, physical as well as emission properties of the polyurethane foam. For example, the siloxane-functional compounds of the present invention can provide a broad processing window for preparation of the foams leading to open-cell foams, which are typically not prone to shrinkage. Additionally, in contrast to linear siloxane compounds, which are also used in the prior art for good distribution of the polyurethane foam in the mould, the siloxane-functional compounds according to the present invention can lead to very low emissions in the common emission tests such as VDA 278, whereby emissions of silicon-containing compounds can be completely avoided within the measurement accuracy. This can make the inventive foams especially useful for applications in automobile interiors, since oil film deposits on the windscreen hampering the sight of the driver can be diminished if not completely eliminated.

### DETAILED DESCRIPTION

The invention is described further and by way of example below without being restricted to these exemplary embodiments. If ranges, general formulas, or classes of compounds are given below, these should not only include the corresponding ranges or groups of compounds that are explicitly mentioned, but also all sub-ranges and sub-groups of compounds that can be obtained by removing individual values (ranges) or compounds. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Any endpoints of ranges and/or numbers within those ranges can be combined within the scope of the present disclosure. If documents are cited in the context of the present description, their content, in particular in relation to the facts in the context in which the document was cited, should completely belong to the disclosure content of the present invention. Unless otherwise stated, parts and percentages are parts and percentages by weight. If parameters are specified below that were determined by measurement, the measurements were carried out, unless otherwise stated, at room temperature (such as 20±5° C., in particular 20° C.) and atmospheric pressure (such as of 101.3±5 kPa, in particular 101 kPa). If chemical (sum) formulas are used in the present invention, the indicated indices can represent both absolute numbers and mean values. In the case of polymeric compounds, the indices typically represent mean values. In the present invention represented structures and empirical formulas represent all isomers conceivable by different arrangement of the repeating units. When within the scope of the present invention oligomeric or polymeric compounds such as polyethers, siloxanes, or polyether siloxanes, are described, which can have different units several times, the units can be randomly distributed (statistical oligomer or polymer), ordered (block oligomer or block polymer) or occur as a gradient distribution in these compounds.

Unless indicated to the contrary, the numerical parameters and ranges set forth in the following specification and appended claims are approximations. Accordingly, unless otherwise expressly specified, all numbers such as those expressing values, ranges, amounts, or percentages may be read as if prefaced by the word “about”, even if the term does not expressly appear. Notwithstanding that the numerical ranges and parameters setting forth the broad scope of the invention are approximations, the numerical values set forth in the specific examples are reported as precisely as possible. Any numerical values, however, contain errors necessarily resulting from the standard deviation in their respective measurement.

As used herein, the term “comprising” is understood to be open-ended and to not exclude the presence of additional undescribed or unrecited elements, materials, ingredients, or method steps etc. The terms “including”, “containing” and like terms are understood to be synonymous with “comprising”. As used herein, the term “consisting of” is understood to exclude the presence of any unspecified element, ingredient, or method step etc. Although the disclosure has been described in terms of “comprising”, “consisting of” or “consisting essentially of” are also within the scope of the present disclosure.

As used herein, the singular form of “a”, “an”, and “the” include plural referents unless the context clearly dictates otherwise.

As already mentioned above, the present invention is directed towards a siloxane-functional compound comprising at least two trisiloxane units bound to a polyether-functional backbone, characterized in that the siloxane-functional compound is represented by Formula (1) in claim 1.

As understood herein, a trisiloxane unit refers to a unit with three silicon atoms bound to each other by siloxane bonds, i.e., Si—O—Si bonds, whereby some or preferably all silicon atoms are further substituted by one or more organic groups such as linear or branched, saturated or unsaturated hydrocarbyl or heteroatom-containing organic groups with the provision that one silicone atom has a bond to the polyether-functional backbone. The trisiloxane unit can be described by empirical formula —Si₃O₂R₇, whereby R denotes the before-mentioned organic group, in particular exemplified by an alkyl group. In a preferred practice of the present invention, some of the organic groups R of the at least two trisiloxane units are alkyl groups and preferably methyl or ethyl groups. In an even more preferred practice of the present invention, all alkyl residues R of the at least two trisiloxane units are methyl groups, i.e., the trisiloxane units are heptamethyl siloxane units. The heptamethyl siloxane unit can be exemplified by the following two structural formulas:

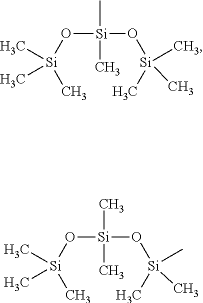

The connection of the trisiloxane units to the polyether-functional backbone is made via silicon-carbon bonds. Thereby, the trisiloxane units can each individually be connected to the polyether-functional backbone via a terminal silicon atom of the respective trisiloxane unit or the central silicon atom of the respective trisiloxane unit. Preferably, all the trisiloxane units of the siloxane-functional compound are connected via the central silicon atom of the respective trisiloxane unit to the polyether-functional backbone. In a particularly preferred practice of the present invention, at least one of the trisiloxane units of the siloxane-functional compound is a 1,1,1,3,5,5,5-heptamethyl trisiloxane unit. In an even more preferred practice, all the trisiloxane units of the siloxane-functional compound are a 1,1,1,3,5,5,5-heptamethyl trisiloxane unit.

The siloxane-functional compound of the present invention can comprise one or more isocyanate-reactive functional groups. An isocyanate-reactive group refers to a functional group that can react with an isocyanate group under the formation of a covalent bond. Typical examples of isocyanate-reactive groups are amine groups such as primary and secondary amine groups and hydroxyl groups. The siloxane-functional compound can comprise a combination of amine groups and hydroxyl groups. The one or more isocyanate-reactive functional groups are typically bound to the polyether-functional backbone of the siloxane-functional compound. The one or more isocyanate-reactive functional groups effect that the siloxane-functional compound of the present invention, when included in a composition for preparing a polyurethane foam, becomes incorporated into the polyurethane network. In this way a dissipation of the siloxane-functional compound from the polyurethane material can be avoided. Alternatively, the molecular structure of the siloxane-functional compound of the present invention does not comprise an isocyanate-reactive functional group; for example, it does not comprise a primary amine, secondary amine and/or hydroxy group. In this case, the siloxane-functional compound is not incorporated into the polyurethane structure and is therefore not consumed in the course of the polymerization reaction. Still, the siloxane-functional compounds of the present invention are not so volatile that they evaporate under common application conditions as reflected for example in VDA method 278 such that typically unwanted stabilizer-related emissions from the obtained polyurethane material are diminished or do not occur. This makes the inventive silicon compound especially attractive for automotive applications.

The siloxane-functional compound of the present invention can be characterized by its boiling point. The boiling point of the siloxane-functional compound can be at least 245° C. or preferably at least 280° C. or more preferably at least 310° C.

The siloxane-functional compound of the present invention can be characterized by its number average molecular weight (Mn). The Mn can for example be determined by gel permeation chromatography preferably based on ISO 13885-1:2020. In a preferred practice of the present invention, the siloxane-functional compound has a number average molecular weight Mn of at least 600 g/mol or preferably at least 800 g/mol or more preferably at least 1000 g/mol and/or of at most 4000 g/mol or preferably at most 3200 g/mol or more preferably at most 3000 g/mol. The number average molecular weight Mn of the siloxane-functional compound can be between any of the recited values such as from 600 g/mol to 4000 g/mol, or preferably from 800 g/mol to 3200 g/mol, or more preferably from 1000 g/mol to 3000 g/mol, whereby the number average molecular weight Mn is determined by gel permeation chromatography.

As already mentioned, the siloxane-functional compound comprises a polyether-functional backbone. As understood herein the term “polyether” denotes that the molecular structure of the backbone comprises at least two ether moieties, i.e., carbon-oxygen-carbon structures. The polyether-functional backbone can comprise beside carbon atoms, hydrogen atoms, and oxygen atoms optionally further heteroatoms such as sulphur atoms. The polyether-functional backbone can be linear or branched and can comprise cyclic units. The polyether-functional backbone can for example comprise one or more linear or branched hydrocarbyl or heteroatom-containing organic moieties such as linear or branched C₂-C₁₀₀ hydrocarbyl or heteroatom-containing organic moieties. The polyether-functional backbone can comprise one or more cyclic, aromatic and/or non-aromatic moieties such as five- or six-membered cyclic moieties. In one practice of the present invention, at least some of the at least two ether moieties of the polyether-functional backbone are derived from ethylene oxide, propylene oxide, and/or butylene oxide. For example, the polyether-functional backbone can be a copolymer whereby the repeating units can be derived from one or more epoxides such as ethylene oxide, propylene oxide, butylene oxide and/or allyl glycidyl ether.

The present invention is illustrated by a structural formula representing the whole siloxane-functional compound. Thus, according to one particularly preferred practice of the present invention, the siloxane-functional compound is represented by Formula (1);

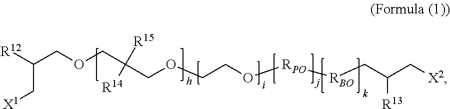

whereby
R_{PO}=

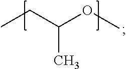

R_{BO}=

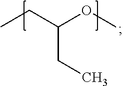

h=1 to 2;
i=0 to 20, preferably 0 to 10, more preferably 0 to 5;
j=0 to 20, preferably 0 to 10, more preferably 0 to 5;
k=0 to 20, preferably 0 to 10, more preferably 0 to 5;
whereby preferably h+i+j+k≥1;
whereby the order of the units with indices h, i, j, and k in Formula (1) is arbitrary, and the units may be in the form of blocks or statistically distributed in the structure of Formula (1);
R¹²=each individually selected from H or CH₃;
R¹³=each individually selected from H or CH₃;
R¹⁴=each individually selected from OH, hydrogen, CH₃, C₂H₅, CH₂OH, or CH₂—O—[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units can be arranged blockwise or statistically distributed;
R¹⁵=each individually selected from hydrogen, CH₃, C₂H₅ or CH₂OH;
R¹⁶=each individually selected from hydrogen, CH₃, CH₂—CH₂—CH₂—X³ or CH₂—C(CH₃)H—CH₂—X⁴;
l=0 to 10, more preferably 1 to 5;
m=0 to 10, more preferably 0 to 5;
n=0 to 10, more preferably 1 to 5;
whereby X¹, X², X³, and X⁴ each individually correspond to an alkyl trisiloxane unit, preferably a heptamethyl trisiloxane unit, more preferably a 1,1,1,3,5,5,5-heptamethyltrisiloxane unit.

Thereby, the structural elements with indices h, i, j, and k are connected via oxygen-carbon bonds, whereby the order of the structural elements in the polyether-functional backbone is arbitrary. Further, the units of the structural elements with indices h, i, j, and k may be arranged as blocks, i.e., as block polymeric units, or may be statistically distributed, i.e., as statistical polymeric units. Thereby, indices h, i, j, and k either denote the actual number of units present in the compound, i.e., only one compound species is present, or, what is the typical case, denote the mean of the units averaged over all representatives of the compound.

In an embodiment of the siloxane-functional compound according to the present invention

$$i = 0 ;$$

$$j = 0 ; and$$

$$k = 0.$$

In another embodiment of the siloxane-functional compound according to the present invention

$$h = 1 ;$$

$$i = 0 ;$$

$$j = 0 ;$$

$$k = 0 ;$$

$${R}^{12} = H ;$$

$${R}^{13} = H ;$$

R¹⁴=CH—O[CH₂—CH₂O]ₗ[CH₂—CH(CH₃)O]ₘ[CH₂—CH(C₂H₅)O]ₒ—R¹⁶; whereby the order of the units with indices l, m, and n in R¹⁴ is arbitrary and the units can be arranged blockwise or statistically distributed;
R¹⁵=C₂H₅;
R¹⁶=hydrogen;
l=0 to 10, more preferably 1 to 5:
m=0 to 10, more preferably 0 to 5;
n=0 to 10, more preferably 1 to 5;
whereby X¹, and X² each individually correspond to an alkyl trisiloxane unit, preferably a heptamethyl trisiloxane unit, more preferably a 1,1,1,3,5,5,5-heptamethyl trisiloxane unit.

In a further embodiment of the siloxane-functional compound according to the present invention
R¹⁴=CH—O[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units can be arranged blockwise or statistically distributed;
l=0 to 10;
m=0 to 5;
n=0 to 10.

In yet another embodiment of the siloxane-functional compound according to the present invention
R¹⁴=CH—O[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units can be arranged blockwise or statistically distributed;
l=1 to 5;
m=0 to 5;
n=1 to 5.

In a preferred embodiment the siloxane-functional compound according to the present invention is

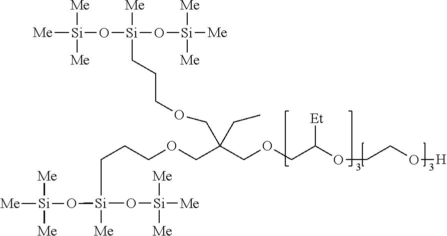

The siloxane-functional compound of the present invention can be obtained by a method comprising reacting a polyether comprising at least two carbon-carbon double bonds reactive to Si—H bonds, i.e., a precursor of the polyether-functional backbone, such as those mentioned hereinbefore, with a hydrogen siloxane in the presence of a catalyst suitable for hydrosilylation, whereby the hydrogen siloxane is a hydrogen trisiloxane, a hydrogen tetrasiloxane or a mixture thereof. In the thus obtained siloxane-functional compound, the residue of the polyether comprising at least two carbon-carbon double bonds reactive to Si—H bonds represents the polyether-functional backbone. The hydrosilylation reaction per se is familiar to the skilled artisan and therefore not described herein in more detail. Suitable catalysts for hydrosilylation comprise for example Pt(0) or rhodium.

A particularly preferred hydrogen trisiloxane for the preparation of the siloxane-functional compounds of the present invention is 1,1,1,3,5,5,5-heptamethyl trisiloxane (HMTS). In case technical HMTS is utilized—which is a preferred option—this may also comprise 1,1,1,3,5,7,7,7-octamethyl tetrasiloxane (OMTS) as a side product. The resulting siloxane-functional compound according to the present invention can therefore comprise a predominant part of heptamethyl trisiloxane beside a minor part of octamethyl tetrasiloxane units.

The polyether comprising at least two carbon-carbon double bonds reactive to Si—H bonds can be prepared as described hereinbefore. In a particularly preferred practice of present invention the polyether comprising at least two carbon-carbon double bonds reactive to Si—H bonds is obtained by reacting an alcohol comprising two carbon-carbon double bonds, preferably trimethylolpropane diallyl ether, with one or more epoxides, preferably selected from ethylene oxide, propylene oxide, and butylene oxide. In an equally preferred alternative practice of the present invention, the polyether comprising at least two carbon-carbon double bonds reactive to Si—H bonds is prepared by reacting an alcohol comprising one carbon-carbon double bond, preferably allyl alcohol, with one or more epoxides, preferably selected from ethylene oxide, propylene oxide, and butylene oxide, followed by reacting with a compound comprising one carbon-carbon double bond and one epoxide group, preferably allyl glycidyl ether, each optionally in the presence of one or more catalysts in catalytical amounts.

The present invention also provides a siloxane composition comprising one or more of the siloxane-functional compounds disclosed herein. The siloxane composition can for example comprise at least one siloxane-functional compound comprising a polyether-functional backbone derived from the polyether of Formula (1) and/or a siloxane-functional compound according to Formula (2) and/or (3). Additionally, the siloxane composition can further comprise at least one siloxane-functional compound as disclosed hereinbefore, wherein one or more of the trisiloxane units are replaced by tetrasiloxane units. Such tetrasiloxane units can comprise octamethyl tetrasiloxane units and preferably 1,1,1,3,5,7,7,7-octamethyltetrasiloxane units. Tetrasiloxane units may stem from the use of technical mixtures of the hydrogen siloxane such as technical 1,1,1,3,5,5,5-heptamethyl trisiloxane (HMTS) in the preparation of the siloxane-functional compounds of the present invention. The use of technical HTMS is advantageous since a costly separation of the hydrogen siloxane species is not needed in this case.

Beside the siloxane-functional compounds discussed hereinabove the siloxane composition can comprise at least one further silicon-containing foam stabilizer and/or at least one silicon-free foam stabilizer known in the art. Suitable examples include non-ionic surfactants such as alcohol alkoxylates. As particular examples for conventional further silicon-containing foam stabilizers, products of the family called TEGOSTAB® from Evonik, Germany, can be mentioned. One particularly suitable further foam stabilizer is TEGOSTAB® B 8734 LF 2.

The total amount of further silicon-containing and silicon-free foam stabilizers in the siloxane composition, if present, can vary. Typically, the total amount of further silicon-containing and silicon-free foam stabilizers in the siloxane composition is 50 wt. % or less, such as 40 wt. % or less, preferably 30 wt. % or less, more preferably 25 wt. % or less, or even more preferably 20 wt. % or less, or 10 wt. % or less, or as low as 0 wt. %, based on the total weight of foam stabilizers in the siloxane composition. The total weight of foam stabilizers in the siloxane composition can include for example beside the amounts of further silicon-containing and silicon-free foam stabilizers the amounts of inventive siloxane-functional compounds and possible side products thereof.

The amount of the inventive siloxane-functional compound(s) (including possible side products thereof) based on the total amount of foam stabilizers in the siloxane composition can vary and can for example be at least 10 weight percent such as at least 20 weight percent, or at least 30 weight percent, or preferably at least 50 weight percent, or more preferably at least 70 weight percent, or even more preferably at least 90 weight percent, or at least 95 weight percent, or at least 99 weight percent, or up to 100 weight percent. The amount of the inventive siloxane-functional compound(s) (including possible side products thereof) based on the total amount of foam stabilizers can be below 100 weight percent such as below 99 weight percent, or below 95 weight percent, or below 90 weight percent, or below 70 weight percent, or below 50 weight percent, or below 30 weight percent, or below 20 weight percent, or below 10 weight percent. The fraction of the inventive siloxane-functional compound(s) (including possible side products thereof) based on the total amount of foam stabilizers in the siloxane composition can be between any of the recited values such as between 10 weight percent and 100 weight percent, or between 20 weight percent and 90 weight percent, or between 30 weight percent and 70 weight percent, or between 40 weight percent and 60 weight percent.

Additionally, the siloxane composition of the present invention can comprise further additives known in the art. For example, the siloxane composition can comprise one or more solvents. The one or more solvents can in particular be organic solvents. As examples of suitable organic solvents monofunctional polyether alcohols can be mentioned such as Synalox 100-15B by DOW or Carpol BP 07100 by Carpenter. By adding one or more solvents to the siloxane composition the foam stabilizer(s) can be diluted thereby improving for instance the meterability or miscibility of the siloxane composition into a reaction matrix such as a composition for preparing a polyurethane foam. The siloxane compositions of the present invention can for example comprise one or more solvents in an amount of 10 wt. % or more such as 20 wt. % or more, or 30 wt. % or more, or 40 wt. % or more, or 50 wt. % or more, or 60 wt. % or more, or 70 wt. % or more, or 80 wt. % or more, or even 90 wt. % or more based on the total weight of the siloxane composition.

As already mentioned above, the siloxane-functional compounds disclosed herein are particularly suited for use in the preparation of polyurethane foams. As such, the present invention is also directed towards the use of the inventive siloxane-functional compounds, or the siloxane composition disclosed hereinbefore as an additive in the production of a polyurethane foam. Thereby, the inventive siloxane-functional compounds can be utilized in the preparation of cold-cure and hot-cure foams, moulded hot- or cold-cure foams, and foams prepared according to the slabstock process, whereby especially the use in cold-cure moulded foams, also known in the art as high-resilience (HR) moulded foams, is particularly preferred. Further, the inventive siloxane-functional compounds are generally useful in the preparation of flexible, semi-rigid, and rigid polyurethane foams.

The siloxane-functional compounds of the present invention can have advantageous properties for controlling the physical properties of the resulting polyurethane foam. Physical properties of foams can for example be tested by force-to-crush measurements. Force-to-crush measurements generally examine the open-cell nature of the foam. In the production of automotive seat cushions, for example, the open-cell nature of the foams is an important parameter to ensure dimensional stability of a moulded article and to prevent shrinkage after demoulding. The polyurethane foams produced in the presence of one or more of the siloxane-functional compounds of the present invention can be characterized by a relatively high inherent stability reflected by the FTC1 value obtained from force-to-crush measurement further specified hereinbelow. Concomitantly, the foams according to the present invention are typically characterized by a low tendency to shrink when cooling down. Moreover, inter alia due to a good stabilization against the influences of shear forces, the obtained foams can exhibit very well regulated and typically defect-free peripheral zones and skins. Additionally, the inventive siloxane-functional compounds can provide an effective control of the cell size and the cell size distribution and may avoid an increased proportion of closed cells in the resulting foams. Importantly, the siloxane-functional compounds of the present invention do not tend to volatilize from the resulting polyurethane foam and therefore can provide foam products with low or no emissions in commonly applied emission tests.

Accordingly, the present invention is also directed to a composition for preparing a polyurethane foam, comprising
(a) at least one isocyanate-reactive compound having in average at least two groups per molecule being reactive to isocyanate groups;
(b) at least one polyisocyanate having in average at least two isocyanate groups per molecule;
(c) at least one blowing agent;
(d) at least one catalyst; and
(e) at least one siloxane-functional compound of the present invention or the siloxane composition of the present invention.

In the composition for preparing a polyurethane foam, components (a) to (d) can comprise substances conventionally known in the art. By way of example, the components and substances disclosed in patent application EP 0 048 984 A2 can be used.

Typically, polyols are utilized as the isocyanate-reactive compound having in average at least two groups per molecule being reactive to isocyanate groups such as in particular at least two hydroxyl groups. Polyols for the production of polyurethane foams are known per se to skilled artisan. Preferred polyols are polyether polyols and polyester polyols commonly used for the production of polyurethane foams. Polyether polyols are obtained by reacting polyvalent alcohols or amines with alkylene oxides. Polyester polyols are based on esters of polyvalent carboxylic acids (usually phthalic or terephthalic acid) with polyvalent alcohols (mostly glycols). Suitable examples of commercially available polyether triols include Arcol® 1374 and Desmophen® 10 WF 15 of Covestro, Germany.

Polyisocyanates for the production of polyurethane foams are also known per se. Suitable polyisocyanates for the purposes of this invention include, e.g., all polyfunctional organic isocyanates, such as 4,4′-diphenylmethane diisocyanate (MDI), toluene diisocyanate (TDI), hexamethylene diisocyanate (HMDI), isophorone diisocyanate (IPDI). Prepolymeric isocyanates are also particularly suitable. As suitable examples of commercially available polyisocyanates SUPRASEC® 2447 of Huntsman Corporation, USA, and DESMODUR® T 80 of Covestro, Germany, can be mentioned.

The ratio of isocyanate groups to towards isocyanate reactive groups, expressed as the NCO index, in the composition of the present invention is preferably in the range from 40 to 500, preferably 60 to 350, particularly preferably 80 to 120. The NCO index describes the ratio of the actually used amount of isocyanate groups to the amount of towards isocyanates reactive groups in the composition needed for a stoichiometric reaction of the NCO groups with the active hydrogen groups of the polyol and other ingredients with active hydrogen groups in the composition. In order to obtain the index, the actual ratio [isocyanate groups]/[towards isocyanate reactive groups] is then multiplied by 100. Accordingly, an NCO index of 100 stands for a molar ratio of the reactive groups of 1 to 1.

As catalysts to produce polyurethane foams in the sense of the present invention all conventionally utilized catalysts known to the skilled artisan that catalyse the polyurethane reaction between polyisocyanates and polyol, also known as gel reaction, are suitable.

Examples of suitable catalysts include the class of tertiary amine compounds that comprise, but are not limited to, the following compounds: triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea and/or amine catalysts of general structure (1a) and/or of structure (1b):

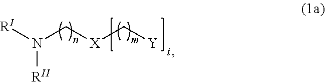

wherein X comprises oxygen, nitrogen, hydroxyl, amino groups of the structure NR^{III} or NR^{III}R^{IV} or urea groups (N(R^{V})C(O)N(R^{VI}) or N(R^{VII})C(O)NR^{VI}R^{VI}); Y comprises amino groups NR^{VII}R^{IX} or alkoxy groups OR^{IX}; R^{I,II} comprise identical or different, linear or cyclic, aliphatic or aromatic hydrocarbon groups having 1-8 carbon atoms that are optionally functionalized with an OH group and/or comprise hydrogen; R^{III-IX} comprise identical or different, linear or cyclic, aliphatic or aromatic hydrocarbon groups having 1-8 carbon atoms that are optionally functionalized with an OH group, an NH or NH₂ group and/or comprise hydrogen; m=0 to 4, preferably 2 or 3; n=2 to 6, preferably 2 or 3; i=0 to 3, preferably 0-2;

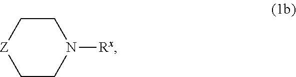

R^{X} comprises identical or different radicals consisting of hydrogen and/or linear, branched, or cyclic, aliphatic, or aromatic hydrocarbon groups having 1-18 carbon atoms, which may be substituted with 0-1 hydroxyl groups and 0-1 NH₂ groups; Z comprises oxygen, N—R^{X} or CH₂.

A further class of suitable catalysts that may be used with preference in the practice of the present invention are metal compounds of the metals Sn, Bi, Zn, Al, or K, in particular Sn, Zn, or Bi. The metal compounds can be divided into the subgroups of organometallic compounds, organometallic salts, organic metal salts and inorganic metal salts, which are explained hereinbelow.

The expression “metalorganic or organometallic compounds” encompasses for the purposes of the present invention in particular the use of metal compounds having a direct carbon-metal bond, here also referred to as metal organyls (e.g., tin organyls) or organometallic/organometal compounds (e.g., organotin compounds). The expression “organometallic or metalorganic salts” encompasses for the purposes of the present invention in particular the use of metalorganic or organometallic compounds having salt character, i.e., ionic compounds in which either the anion or cation is organometallic in nature (e.g., organotin oxides, organotin chlorides, or organotin carboxylates). The expression “organic metal salts” encompasses for the purposes of the present invention in particular the use of metal compounds that do not have any direct carbon-metal bond and are at the same time metal salts in which either the anion or the cation is an organic compound (e.g., tin(II) carboxylates). The expression “inorganic metal salts” encompasses for the purposes of the present invention in particular the use of metal compounds or of metal salts in which neither the anion nor the cation is an organic compound, e.g. metal chlorides (e.g., tin(II) chloride).

Organic and organometallic metal salts that are suitable for use contain preferably alkoxide, mercaptate or carboxylate anions, such as acetate, 2-ethylhexanoate, octanoate, isononanoate, decanoate, neodecanoate, ricinoleate, laurate and/or oleate, particularly preferably 2-ethylhexanoate, ricinoleate, neodecanoate or isononanoate.

As a general rule, metal-containing catalysts that are suitable for use are preferably selected such that they do not have any troublesome intrinsic odor and are essentially toxicologically safe, and such that the resulting polyurethane systems, especially polyurethane foams, have the lowest possible degree of catalyst-related emissions.

In the case of compositions for preparing a polyurethane froth foam, thermo-latent catalysts, i.e., catalysts which only develop their effectiveness above a certain activation temperature and thus allow the foams to cure more slowly, are particularly suitable.

Suitable catalysts for compositions for preparing a polyurethane foam also comprise gel catalysts.

In a preferred practice of the invention, the inventive siloxane-functional compounds or siloxane compositions are used in the composition for preparing a polyurethane foam in combination with tertiary amine catalysts according to structure (1a), whereby the latter comprise at least one towards isocyanate groups reactive group especially hydroxyl (OH), or amino (N—H, NH₂) groups.

It may also be preferable to combine one or more metal compounds such as those mentioned hereinbefore with one or more amine catalysts of formula (1a) and/or (1b).

Specific examples of particularly suitable catalysts include catalysts of the DABCO® and Polycat® series of Evonik®, Germany, such as DABCO® DMEA (an amine catalyst), DABCO® NE 300, and DABCO® NE 1550.

The amount of catalyst(s) in the composition for preparing a polyurethane foam can vary and depend inter alia on the nature and function of the catalysts. For example, the total amount of catalysts in the composition can be 10 pphp or less such as 5 pphp or less, or preferably 2 pphp or less, or more preferably 1 pphp or less, or 0.001 pphp or more such as 0.01 pphp or more, or 0.1 pphp or more, or 0.5 pphp or more. The total amount of catalysts can be between any of the recited values such as between 10 pphp and 0.001 pphp, or preferably between 0.01 and 5 pphp, or more preferably between 0.1 pphp and 1 pphp. The unit pphp thereby refers to parts (grams) per 100 g of polyol.

Foaming can be accomplished by employing a suitable amount of one or more blowing agents in the composition for preparing a polyurethane foam. Blowing agents are generally known in the art and include for example water, methylene chloride, liquefied gases, or other inert gases such as nitrogen, carbon dioxide added as such, iso- and cyclo-pentane, methane, helium, and argon. Suitable liquefied gases include aliphatic and cycloaliphatic fluorocarbons which vaporize at or below the temperature of the foaming mass. Such gases are at least partially fluorinated and may also be otherwise halogenated. Fluorocarbon blowing agents suitable for use in foaming compositions of the present invention for preparing rigid polyurethane foams include trichloromonofluoromethane, dichlorodifluoromethane, 1,1-dichloro-1-fluoroethane, 1,1,1-trifluoro-2-fluoro-3,3-difluoro-4,4,4 -trifluorobutane, hexafluoro-cyclobutene, octafluorocyclobutane, and hydro-fluorinated olefines.

Another useful class of blowing agents include thermally-unstable compounds which liberate gases upon heating, such as N,N′-dimethyl-N,N′-dinitrosoterephthalamide. A particularly preferred blowing agent is water, which reacts with the polyisocyanate compound of the composition under the formation of carbon dioxide. The amount of blowing agent(s) in the composition can vary. For example, the total amount of blowing agent(s) in the composition can be 10 pphp or less such as preferably 7 pphp or less, or more preferably 5 pphp or less, or 0.1 or more such as preferably 1 pphp or more, or preferably 2 pphp or more. The total amount of blowing agents can be between any of the recited values such as between 0.1 and 10 pphp, or preferably between 1 pphp and 7 pphp, or more preferably between 2 pphp and 5 pphp.

In addition to the components mentioned hereinbefore, the composition for preparing a polyurethane foam can also contain other additives and auxiliary agents conventionally used in the art, as needed. By way of example the composition for preparing a polyurethane foam can for example comprise one or more of additives selected from the group comprising dyes, pigments, fillers, antistatic additives, crosslinkers, chain extenders, cell openers, nucleating agents, thickeners, fragrances, cell expanders, plasticizers, hardening promoters, additives for preventing cold flow, aldehyde scavengers, additives for increasing resistance of polyurethane foams towards hydrolysis, compatibilizers (emulsifiers), adhesion promoters, and hydrophobization additives. The total amount of additives and auxiliary agents can vary and can be 10 pphp or less such as 8 pphp or less, or 5 pphp or less, or 3 pphp or less.

The amount of the at least one siloxane-functional compound of the present invention or the siloxane composition of the present invention in the composition for preparing polyurethane foams can vary. The amount may for example be at least 0.0001 wt. % or more, such as 0.001 wt. % or more, or 0.01 wt. % or more, based on the total weight of the composition. The amount may be 10 wt. % or less, such as 5 wt. % or less, or 2 wt. % or less, based on the total weight of the composition. The at least one siloxane-functional compound or the siloxane composition of the present invention can be present in the composition in an amount between any of the recited values such as from 0.0001 wt. % to 10 wt. %, or preferably from 0.001 wt. % to 5 wt. %, or more preferably from 0.01 wt. % to 2 wt. % based on the total weight of the composition.

The amount of the at least one siloxane-functional compound of the present invention in the composition for preparing a polyurethane foam can alternatively be expressed in parts (grams) per 100 g of polyol abbreviated as pphp. In a preferred practice of the present invention, the amount of the at least one siloxane-functional compound of the present invention can be at least 0.001 pphp such as at least 0.005 pphp, or at least 0.01 pphp, or at least 0.02 pphp, or at least 0.03 pphp, or at least 0.05 pphp, and/or at most 1.5 pphp such as at most 1.0 pphp, or at most 0.5 pphp, or at most 0.1 pphp, or at most 0.05 pphp. The amount of the at least one siloxane-functional compound may be between any of the recited values such as from 0.001 pphp to 1.5 pphp, or preferably from 0.005 pphp to 0.1 pphp. In case the composition comprises more than one of the siloxane-functional compounds of the present invention, the above amounts refer to the sum of the amounts of the individual siloxane-functional compounds and thus to the total amount of the inventive siloxane-functional compounds in the respective composition for preparing a polyurethane foam.

The composition for preparing a polyurethane foam can optionally comprise one or more further silicon-containing foam stabilizers different from the siloxane-functional compounds of the present invention and/or one or more silicon-free foam stabilizers. The total amount of further silicon-containing and silicon-free foam stabilizers in the composition, if present, can vary and may for example be at least 0.05 pphp such as at least 0.07 pphp, or at least 0.1 pphp, or at least 0.2 pphp, or at least 0.3 pphp, or at least 0.5 pphp, and/or at most 1.5 pphp such as at most 1.4 pphp, or at most 1.3 pphp, or at most 1.2 pphp. The total amount of further silicon-containing and silicon-free foam stabilizers in the composition can be between any of the recited values such as from 0.05 pphp to 1.5 pphp, or from 0.05 pphp to 0.2 pphp. Preferably, however, the compositions for preparing polyurethanes only comprise one or more of the siloxane-functional compounds of the present invention and are free of conventionally applied further silicon-containing and silicon-free foam stabilizers.

The composition for preparing a polyurethane foam can also comprise the siloxane composition of the present invention described hereinbefore. The siloxane composition can comprise one or more of the siloxane-functional compounds of the present invention and possible side products thereof as well as optionally one or more further silicon-containing and silicon-free foam stabilizers as detailed above. The amount of the siloxane composition in the polyurethane composition can vary and can be for example at least 0.05 pphp such as at least 0.07 pphp, or at least 0.1 pphp, or at least 0.2 pphp, or at least 0.3 pphp, or at least 0.5 pphp, and/or at most 1.5 pphp such as at most 1.4 pphp, or at most 1.3 pphp, or at most 1.2 pphp. The amount of the siloxane composition in the composition for preparing a polyurethane foam can be between any of the recited values such as from 0.05 pphp to 1.5 pphp, or from 0.05 pphp to 0.2 pphp. In case the siloxane composition comprises one or more solvents the amount of the one or more solvents is not taken into consideration for the calculation of the amount of the siloxane composition in the polyurethane composition.

The polyurethane foam according to the present invention can be prepared by a method, comprising
(i) providing a composition comprising at least one isocyanate-reactive compound having in average at least two groups being reactive to isocyanate groups, at least one siloxane-functional compound of the present invention or a siloxane composition according to the present invention, at least one blowing agent, at least one catalyst, and optionally one or more further additives;
(ii) contacting the composition with a polyisocyanate having in average at least two isocyanate groups per molecule or a mixture of polyisocyanates; and
(iii) curing the composition under the formation of a polyurethane foam.

The production of the polyurethane foams may in principle be carried out in a customary manner and as described in the prior art. The preparation of polyurethane foams is per se known to the skilled artisan. A comprehensive overview is found, for example, in G. Oertel, Polyurethane Handbook, 2nd edition, Hanser/Gardner Publications Inc., Cincinnati, Ohio, 1994, pp. 177-247. Further details of the starting materials, catalysts, and auxiliaries and additives that may be used can be found, for example, in Kunststoffhandbuch [Plastics Handbook], volume 7, Polyurethane [Polyurethanes], Carl-Hanser-Verlag Munich, 1st edition 1966, 2nd edition 1983 and 3rd edition 1993.

Further, it is to be understood that the method steps as defined herein are not subject to a fixed chronological sequence. Thus, the curing may already occur when the composition is contacted with the polyisocyanate.

In a preferred practice of the present invention, the method for preparing a polyurethane foam is a method for preparing a moulded polyurethane foam. To this end, the method can comprise a step of transferring the composition including the polyisocyanate to a mould prior to curing of the composition. Thereby, the mould can be pre-heated such as to a temperature between 40° C. and 60° C. or to higher temperatures.

The present invention is also directed to a polyurethane foam prepared in the presence of at least one siloxane-functional compound of the present invention, preferably according to the method disclosed hereinbefore. Thereby, the polyurethane foam of the present invention can be a flexible polyurethane foam, a rigid polyurethane foam, a semi rigid polyurethane foam, a moulded polyurethane foam, a high resilience polyurethane foam, a viscoelastic foam, a hypersoft polyurethane foam, or an integral foam. In a preferred practice of the present invention, the inventive polyurethane foam is a moulded polyurethane foam.

The inventive polyurethane foam can be characterized by its emission characteristics as determined according to the thermal desorption analysis method described in VDA standard 278 and the experimental section hereinbelow. In a preferred practice of the present invention, the polyurethane foam has a VOC (volatile organic compounds) value according to VDA 278 of 40 ppm or less such as 30 ppm or less, or 20 ppm or less, or 10 ppm or less, or 5 ppm or less, or even 0 ppm. The polyurethane foam can have a FOG value reflecting the proportion of condensable substances according to VDA 278 of 250 ppm or less, such as 200 ppm or less, or 150 ppm or less, or 100 ppm or less, or 50 ppm or less, or 20 ppm or less, or 10 ppm or less.

The inventive polyurethane foam can especially be characterized by a low emission of silicon-containing species. The emission of silicon-containing substances can be described by the silicon-containing volatile organic compounds value (silicon-containing VOC value) and the proportion of condensable silicon-containing substances (silicon-containing FOG value) determined according to VDA method 278 and the method described in the experimental section hereinbelow. In a particularly preferred practice of the present invention, the silicon-containing VOC value of the inventive polyurethane foam is 10 ppm or less, such as 7 ppm or less, or preferably 5 ppm or less, or even 0 ppm. The proportion of condensable silicon-containing substances (silicon-containing FOG value) can be 10 ppm or less, such as 7 ppm or less, or preferably 5 ppm or less, or even 0 ppm.

The polyurethane foam according to the present invention can be characterized by the number of cells per cm, i.e., the cell count, as determined according to DIN EN 15702:2009-04. Accordingly, the value of the cell count may be at least 7.0 such as at least 8.0, or at least 9.5 and/or at most 12.0, such as at most 11.5, or at most 11.0. The value of the cell count can be between any of the recited values such as from 7.0 to 12.0, or from 8.0 to 11.0.

Furthermore, the polyurethane foams according to the invention are preferably distinguished by an inherent stability or crush hardness reflected by the FTC1 value in Newton determined according to the force-to-crush measurement described in the experimental section hereinbelow. The FTC1 value for the inventive polyurethane foams is preferably at least 900 N such as at least 950 N, or at least 1000 N, or at least 1050 N, or at least 1100 N. The FTC1 value is typically at most 1500 N such as at most 1450 N, or at most 1400 N. The FTC1 value can be between any of the recited values such as from 900 N to 1500 N, or from 1000 N to 1400 N.

The present invention also relates to an article consisting of or comprising a polyurethane foam of the present invention. In a preferred practice of the present invention, the article is a refrigerator insulation, an insulation panel, a sandwich element, a pipe insulation, a spray foam, a 1- or 1.5-component can foam, an imitation wood, a modelling foam, a packaging foam, a mattress, a furniture cushioning, an automotive seat cushioning, a seat cushioning in a plane or a train, a headrest, an armrest, an instrument panel, an automotive interior trim, an automotive headlining, a sound absorption material, a steering wheel, a shoe sole, a carpet backing foam, a filter foam, a sealing foam, a sealant, an adhesive, or a coating. In a more preferred practice of the present invention, the article is an automotive seat cushioning, an instrument panel, a sound absorption material, a headrest, an armrest, an automotive headlining, or a steering wheel. Even more preferably the article is an automotive seat cushioning. The polyurethane foam of the present invention can also be used for or in the manufacture of articles such as the ones mentioned hereinbefore.

Aspects of the invention include, but are not limited to, the following numbered clauses:
1. A siloxane-functional compound comprising at least two trisiloxane units bound to a polyether-functional backbone.
2. The siloxane-functional compound according to clause 1, wherein at least one of the trisiloxane units comprises a heptamethyl trisiloxane unit, preferably a 1,1,1,3,5,5,5-heptamethyltrisiloxane unit.
3. The siloxane-functional compound according to clause 1 or 2, wherein the at least two trisiloxane units are each individually bound to the polyether-functional backbone via a Si—C bond.
4. The siloxane-functional compound according to any of clauses 1 to 3, wherein the molecular structure of the siloxane-functional compound does not comprise an isocyanate-reactive functional group or wherein the molecular structure of the siloxane-functional compound comprises at least one isocyanate-reactive functional group, preferably at least one hydroxyl group.
5. The siloxane-functional compound according to any of clauses 1 to 4, wherein the polyether-functional backbone comprises two or more ether moieties derived from ethylene oxide, propylene oxide, and/or butylene oxide.
6. The siloxane-functional compound according to any of clauses 1 to 5, wherein the siloxane-functional compound has a number average molecular weight (Mn) in the range of from 600 g/mol to 4000 g/mol, preferably from 800 g/mol to 3200 g/mol, or more preferably from 1000 g/mol to 3000 g/mol.
7. The siloxane-functional compound according to any of clauses 1 to 6, wherein the polyether-functional backbone is derived from a polyether comprising at least two carbon-carbon double bonds represented by general Formula (1), which can be converted by hydrosilylation with a hydrogen trisiloxane to the siloxane-functional compound:

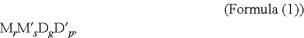

whereby
M=X—(O_{1/2}), preferably

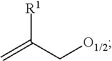

M′=X′−(O_{1/2})
D=Y−(O_{1/2})₂, preferably each individually selected from

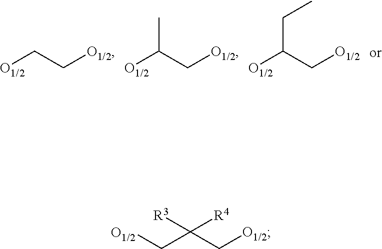

D′=Y′−(O_{1/2})₂, preferably each individually selected from

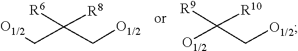

r=0 to 2, preferably 1 or 2;
s=0 to 2, preferably 0 or 1;
g=0 to 65, preferably 0 to 35, more preferably 1 to 15;
p=0 to 10, preferably 0 to 5, more preferably 0 to 3;
X=each individually selected from monovalent, linear or branched hydrocarbyl moiety with 1 to 20 carbon atoms having a carbon-carbon double bond reactive to Si—H bonds;
X′=each individually selected from hydrogen, a monovalent linear or branched ethylenically saturated hydrocarbyl moiety with 1 to 20 carbon atoms, C₆H₅, or C(O)—R², preferably hydrogen, or a monovalent linear or branched ethylenically saturated hydrocarbyl moiety with 1 to 8 carbon atoms, more preferably hydrogen or a monovalent linear or branched ethylenically saturated hydrocarbyl moiety with 1 to 4 carbon atoms;
Y=each individually selected from divalent, linear or branched, ethylenically saturated organyl moiety with ≥2 carbon atoms;
Y′=each individually selected from divalent, linear or branched organyl moiety with ≥2 carbon atoms having a carbon-carbon double bond reactive to Si—H bonds;
R¹=each individually selected from hydrogen or alkyl with 1 to 10 carbon atoms, preferably hydrogen or methyl, more preferably hydrogen;
R²=each individually selected from hydrogen, CH₃, C₂H₅, CH₂C₆H₅, or C(O)CH₃;
R³=each individually selected from OH, hydrogen, CH₃, C₂H₅, CH₂OH, or CH₂—O—[CH₂—CH₂O]ₐ[CH₂—CH(CH₃)O]_{b}[CH₂—CH(C₂H₅)O]_{c}—R⁵; whereby the order of the units with indices a, b, and c in R³ is arbitrary and the units can be arranged blockwise or statistically distributed;
R⁴=each individually selected from hydrogen, CH₃, C₂H₅, or CH₂OH;
R³=each individually selected from hydrogen, CH₃, C₂H₅, or CH₂OH;
R¹⁰=each individually selected from hydrogen, CH₃, C₂H₅, or CH₂OH;
R⁵=each individually selected from hydrogen or CH₃;
R⁶=CH₂—O—[CH₂—CH₂O]_{d}[CH₂—CH(CH₃)O]ₑ[CH₂—CH(C₂H₅)O]_{f}—R⁷; whereby the order of the units with indices d, e, and f in R⁶ is arbitrary and the units can be arranged blockwise or statistically distributed;
R⁹=CH₂—O—[CH₂—CH₂O]ₓ[CH₂—CH(CH₃)O]_{y}[CH₂—CH(C₂H₅)O]_{z}—R¹¹; whereby the order of the units with indices x, y, and z in R⁹ is arbitrary and the units can be arranged blockwise or statistically distributed;
R⁷=each individually selected from hydrogen, CH₂—CH═CH₂ or CH₂—C(CH₃)=CH₂;
R⁹=each individually selected from hydrogen, CH₂—CH═CH₂ or CH₂—C(CH₃)=CH₂;
a=0 to 10, more preferably 1 to 5;
b=0 to 10, more preferably 0 to 5;
c=0 to 10, more preferably 1 to 5;
d=0 to 10, more preferably 1 to 5;
e=0 to 10, more preferably 0 to 5;
f=0 to 10, more preferably 1 to 5;
x=0 to 10, more preferably 1 to 5;
y=0 to 10, more preferably 0 to 5;
z=0 to 10, more preferably 1 to 5;
with the proviso that r+p≥2;
with the proviso that g+p≥1, preferably 3;
with the proviso that s+r=2.
8. The siloxane compound according to clause 7, wherein in Formula (1)

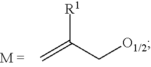

D=each individually selected from

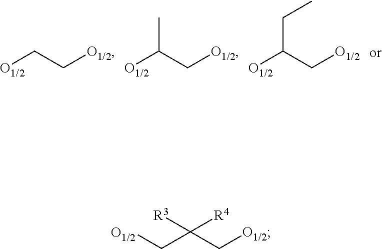

D′=each individually selected from

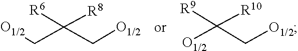

9. The siloxane-functional compound according to any of clauses 1 to 8, wherein the siloxane-functional compound is represented by Formula (2);

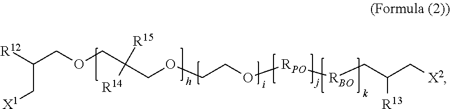

whereby
R_{PO}=

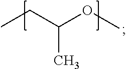

R_{BO}=

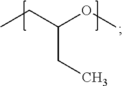

h=0 to 2, preferably 0 or 1;
i=0 to 20, preferably 0 to 10, more preferably 0 to 5;
j=0 to 20, preferably 0 to 10, more preferably 0 to 5;
k=0 to 20, preferably 0 to 10, more preferably 0 to 5;
whereby preferably h+i+j+k≥1, more preferably h+i+j+k>3;
whereby the order of the units with indices h, i, j, and k in Formula (2) is arbitrary, and the units may be in the form of blocks or statistically distributed in the structure of Formula (2);
R¹²=each individually selected from H or CH₃;
R¹³=each individually selected from H or CH₃;
R¹⁴=each individually selected from OH, hydrogen, CH₃, C₂H₅, CH₂OH, or CH₂—O—[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units can be arranged blockwise or statistically distributed;
R¹⁵=each individually selected from hydrogen, CH₃, C₂H₅ or CH₂OH;
R¹⁶=each individually selected from hydrogen, CH₃, CH₂—CH₂—CH₂—X³ or CH₂—C(CH₃)H—CH₂—X⁴;
l=0 to 10, more preferably 1 to 5;
m=0 to 10, more preferably 0 to 5;
n=0 to 10, more preferably 1 to 5;
whereby X¹, X², X³, and X⁴ each individually correspond to an alkyl trisiloxane unit, preferably a heptamethyl trisiloxane unit, more preferably a 1,1,1,3,5,5,5-heptamethyltrisiloxane unit.
10. The siloxane-functional compound according to clause 7 or 8, wherein in Formula (1)
   M=

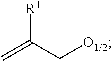

D=

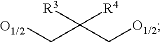

p=0;
r=2;
s=0;
g=1;
R¹=hydrogen;
R³=each individually selected from CH₂—O—[CH₂—CH₂O]ₐ[CH₂—CH(CH₃)O]_{b}[CH₂—CH(C₂H₅)O]_{c}—R⁵; whereby the order of the units with indices a, b, and c in R³ is arbitrary and the units can be arranged blockwise or statistically distributed;
R⁴=C₂H₅;
R⁵=hydrogen;
a=0 to 5;
b=0 to 5;
c=0 to 5;
whereby a+b+c≤3.
11. The siloxane-functional compound according to any of clauses 1 to 8, wherein the siloxane-functional compound is represented by Formula (3);

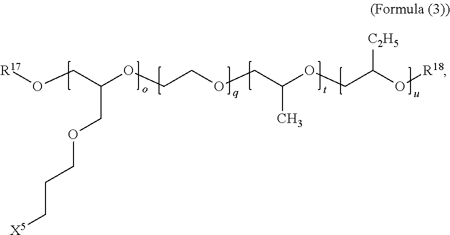

whereby
o=1 to 10, preferably 1 to 5, more preferably 1 to 2;
q=0 to 20, preferably 0 to 10, more preferably 0 to 5;
t=0 to 20, preferably 0 to 10, more preferably 0 to 5;
u=0 to 20, preferably 0 to 10, more preferably 0 to 5;
whereby the order of the units with indices o, q, t, and u in Formula (3) is arbitrary, and the units are in the form of blocks or statistically distributed in the structure of Formula (3);
R¹⁷=each individually selected from hydrogen, alkyl with 1 to 16 carbon atoms, CH₂—CH₂—CH₂—X⁶, CH₂—C(CH₃)H—CH₂—X⁷, C₆H₅, or C(O)—R¹⁹, preferably H, alkyl with 1 to 8 carbon atoms, CH₂—CH₂—CH₂—X⁶, or CH₂—C(CH₃)H—CH₂—X⁷, more preferably H, CH₂—CH₂—CH₂—X⁶, or CH₂—C(CH₃)H—CH₂—X⁷;
R¹⁸=each individually selected from hydrogen, alkyl with 1 to 16 carbon atoms, CH₂—CH₂—CH₂—X⁶, CH₂—C(CH₃)H—CH₂—X⁷, C₆H₅, or C(O)—R¹⁹, preferably H, alkyl with 1 to 8 carbon atoms, CH₂—CH₂—CH₂—X⁶, or CH₂—C(CH₃)H—CH₂—X⁷, more preferably H, CH₂—CH₂—CH₂—X⁶, or CH₂—C(CH₃)H—CH₂—X⁷;
R¹⁹=each individually selected from hydrogen, CH₃, C₂H₅, CH₂C₆H₅, or C(O)CH₃; whereby X⁵ to X⁷ each individually correspond to an alkyl trisiloxane unit, preferably a heptamethyl trisiloxane unit, more preferably a 1,1,1,3,5,5,5-heptamethyltrisiloxane unit; and
whereby o≥2 when R¹⁷ and R¹⁸ together do not comprise siloxane units and whereby o 1 when R¹⁷ and R¹⁸ together do comprise one siloxane unit.
12. The siloxane-functional compound according to clause 7 or 8, wherein in Formula (1)
   M=

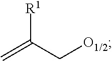

D=each individually selected from

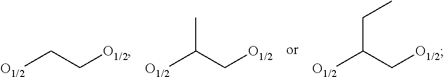

D′=

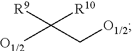

X′=hydrogen;
r=1
s=1;
g 1 to 15;
p=1 to 3;
R¹=hydrogen;
R⁹=CH₂—O—[CH₂—CH₂O]ₓ[CH₂—CH(CH₃)O]_{y}[CH₂—CH(C₂H₅)O]_{z}—R¹¹; whereby the order of the units with indices x, y, and z in R⁹ is arbitrary and the units can be arranged blockwise or statistically distributed;
R¹⁰=hydrogen;
R¹¹=CH₂—C(CH₃)=CH₂;
x=0 to 5;
y=0 to 5;
z=0 to 5.
13. The siloxane-functional compound according to any of clauses 7, 8, 10, or 12, wherein the polyether comprising at least two carbon-carbon double bonds of Formula (1) is obtained by reacting an alcohol having at least one carbon-carbon double bond reactive to Si—H bonds with one or more epoxides, and optionally with a compound comprising a carbon-carbon double bond reactive to Si—H bonds and an epoxy group.
14. The siloxane-functional compound according to clause 13, wherein the reaction is carried out in the presence of one or more catalysts in catalytic amounts.
15. The siloxane-functional compound according to clause 13 or 14, wherein the alcohol having at least one carbon-carbon double bond reactive to Si—H bonds is selected from (meth)allyl alcohol, and trimethylolpropane diallyl ether.
16. The siloxane-functional compound according to any of clauses 13 to 15, wherein the one or more epoxides are selected from ethylene oxide, propylene oxide, and 1,2-butylene oxide.
17. The siloxane-functional compound according to any of clauses 13 to 16, wherein the compound comprising a carbon-carbon double bond reactive to Si—H bonds and an epoxy group is allyl glycidyl ether.
18. A siloxane composition comprising one or more of the siloxane-functional compounds according to clauses 1 to 17 and optionally one or more further silicon-containing and/or silicon-free foam stabilizers.
19. The siloxane composition according to clause 18, wherein the siloxane composition further comprises one or more siloxane-functional compounds(s) as defined in clauses 1 to 17, wherein one or more trisiloxane unit(s) are replaced by tetrasiloxane unit(s), and wherein at least one of the tetrasiloxane units optionally comprises an octamethyl tetrasiloxane unit, preferably a 1,1,1,3,5,7,7,7-octamethyltetrasiloxane unit.
20. A composition for preparing a polyurethane foam, comprising
   a) at least one isocyanate-reactive compound having in average at least two groups per molecule being reactive to isocyanate groups;
   b) at least one polyisocyanate having in average at least two isocyanate groups per molecule; c) at least one blowing agent;
   d) at least one catalyst;
   e) at least one siloxane-functional compound according to any of clauses 1 to 17 or a siloxane composition according to clause 18 or 19; and
   f) optionally one or more additives selected from the group comprising dyes, pigments, fillers, antistatic additives, crosslinkers, chain extenders, cell openers, nucleating agents, thickeners, fragrances, cell expanders, plasticizers, hardening promoters, additives for preventing cold flow, aldehyde scavengers, additives for increasing resistance of polyurethane foams towards hydrolysis, compatibilizers (emulsifiers), adhesion promoters, and hydrophobization additives.
21. The composition according to clause 20, wherein the at least one siloxane-functional compound or the siloxane composition is present in the composition in an amount of from 0.0001 wt. % to 10 wt. %, preferably from 0.001 wt. % to 5 wt. % or more preferably from 0.01 wt. % to 2 wt. % based on the total weight of the composition.
22. A method for preparing a polyurethane foam, comprising
   providing a composition comprising at least one isocyanate-reactive compound having in average at least two groups being reactive to isocyanate groups, at least one siloxane-functional compound according to any of clauses 1 to 17 or a siloxane composition according to clause 18 or 19, at least one blowing agent, at least one catalyst, and optionally one or more further additives;
   contacting the composition with a polyisocyanate having in average at least two isocyanate groups per molecule or a mixture of polyisocyanates; and
   curing the composition under the formation of a polyurethane foam.
23. A polyurethane foam prepared in the presence of at least one siloxane-functional compound according to any of clauses 1 to 17, preferably according to the method of clause 22, wherein the polyurethane foam is preferably a flexible polyurethane foam, a rigid polyurethane foam, a semi rigid polyurethane foam, a moulded polyurethane foam, a high resilience polyurethane foam, a viscoelastic foam, a hypersoft polyurethane foam, or an integral foam, more preferably a moulded polyurethane foam.
24. The polyurethane foam according to clause 23, wherein the polyurethane foam exhibits one or both of
   a silicon-containing volatile organic compounds (silicon-containing VOC) value determined according to VDA standard 278 of 10 ppm or less, preferably 5 ppm or less;
   a proportion of condensable silicon-containing substances (Si-containing FOG value) determined according to VDA standard 278 of 10 ppm or less, preferably 5 ppm or less.
25. An article comprising the polyurethane foam according to clause 23 or 24, wherein the article preferably is a refrigerator insulation, an insulation panel, a sandwich element, a pipe insulation, a spray foam, a 1- or 1.5-component can foam, an imitation wood, a modelling foam, a packaging foam, a mattress, a furniture cushioning, an automotive seat cushioning, a seat cushioning in a plane or a train, a headrest, an armrest, an instrument panel, an automotive interior trim, an automotive headlining, a sound absorption material, a steering wheel, a shoe sole, a carpet backing foam, a filter foam, a sealing foam, a sealant, an adhesive, a coating, or for use in manufacturing corresponding products, or more preferably an automotive seat cushioning, an instrument panel, a sound absorption material, a headrest, an armrest, an automotive headlining, a steering wheel, or even more preferably an automotive seat cushioning.
26. A method of preparing the siloxane-functional compound according to any of clauses 1 to 17 comprising reacting a polyether comprising at least two carbon-carbon double bonds reactive to Si—H bonds with a hydrogen siloxane in the presence of a catalyst suitable for hydrosilylation, whereby the hydrogen siloxane is a hydrogen trisiloxane, a hydrogen tetrasiloxane or a mixture thereof.
27. The method according to clause 26, wherein the hydrogen siloxane is 1,1,1,3,5,5,5-heptamethyltrisiloxane or 1,1,1,3,5,7,7,7-octamethyltrisiloxane, or mixtures thereof.
28. The method according to clause 26 or 27, wherein the polyether comprising at least two carbon-carbon double bonds reactive to Si—H bonds is as defined in any one of clauses 7, 8, 10, 12, or 13 to 17.
29. The method according to any of clauses 26 to 28, wherein the polyether comprising at least two carbon-carbon double bonds reactive to Si—H bonds is prepared by reacting an alcohol comprising two carbon-carbon double bonds, preferably trimethylolpropane diallyl ether, with one or more epoxides, preferably selected from ethylene oxide, propylene oxide, and butylene oxide, optionally in the presence of one or more catalysts in catalytical amounts.
30. The method according to any of clauses 26 to 28, wherein the polyether comprising at least two carbon-carbon double bonds reactive to Si—H bonds is prepared by reacting an alcohol comprising one carbon-carbon double bond, preferably allyl alcohol, with one or more epoxides, preferably selected from ethylene oxide, propylene oxide, and butylene oxide, followed by reacting with a compound comprising a carbon-carbon double bond reactive to Si—H bonds and one epoxy group, preferably allyl glycidyl ether, each optionally in the presence of one or more catalysts in catalytical amounts.
31. Use of the siloxane-functional compound according to any of clauses 1 to 17 or the siloxane composition according to any of clauses 18 or 19 as an additive in the production of a polyurethane foam.

In the examples set forth below, the present invention is described by way of example without intending to limit the invention, whose breath of application is determined by the entire description and claims, to the embodiments set forth in the examples.

### Examples

All amounts referred to throughout the examples are parts by weight, unless otherwise noted.
1. Synthesis of the polyether precursor for the preparation of siloxane-functional compounds
1.1 Synthesis of Polyether 1 (PE1)

To prepare a polyether PE1, 561.6 g of trimethylolpropane diallyl ether (obtained from Perstorp, Malmö, Sweden, as Trimethylolpropane Diallylether 90, purity 90% or more) and 9.8 g of sodium methylate were placed under nitrogen in a 3-liter autoclave. Then, the reaction mixture was heated to 115° C. while stirring and evacuated to an internal pressure of 100 mbar to remove volatile ingredients by distillation. 60.0 g of propylene oxide were added under constant stirring and cooling to keep the temperature of the reaction mixture at 115° C. After a recognizable drop in pressure, further 676.0 g of propylene oxide were added continuously over two hours while stirring and cooling to keep the temperature of the reaction mixture at 115° C. and at an (absolute) internal reactor pressure of max. 3.0 bar. After complete addition and a subsequent additional reaction time of 2.5 hours, the reactor was degassed again, the reaction mixture was cooled to 95° C., the reaction mixture was neutralized with H₃PO₄ (i.e., 30 wt. % of H₃PO₄ in water, based on the total mass of the solution), and 500 ppm of Anox 20 AM® based on the total mass of the composition were added. Water was removed by means of a vacuum distillation and precipitated salts were filtered off. 1273.5 g of a yellow, clear polyether were thus obtained. The below reproduced structure PE1 of the polyether was determined by means of ¹H NMR, hydroxyl value, and iodine value determination. Thereby, PE1 is an average formula, in which the number of the repeating unit represents a mean value averaged over all representatives of the compound.

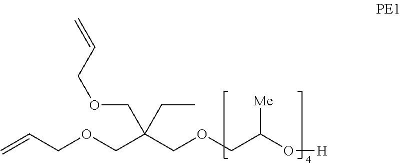

### 1.2 Synthesis of Polyether 2 (PE2)

To prepare a polyether PE2, 281.3 g of trimethylolpropane diallyl ether (obtained from Perstorp, Malmö, Sweden, as Trimethylolpropane Diallylether 90, purity 90% or more) and 4.9 g of sodium methylate were placed under nitrogen in a 3-liter autoclave. Then, the reaction mixture was heated to 115° C. while stirring and evacuated to an internal pressure of 100 mbar to remove volatile ingredients by distillation. 50.0 g of a mixture of ethylene oxide (EO) and 1,2-butyleneoxide (BO) with a molar ratio of EO and BO equal to 3:2 were added under stirring and cooling to keep the temperature of the reaction mixture at 115° C. After a recognizable pressure drop, further 392.0 g of a mixture of ethylene oxide (EO) and 1,2-butyleneoxide (BO) with a molar ratio of EO and BO equal to 3:2 were added continuously over one hour and under stirring and cooling to keep the temperature of the reaction mixture at 115° C. and at an (absolute) internal reactor pressure of max. 3.0 bar. After an additional subsequent reaction time of 1 hour, 116.0 g of 1,2-butyleneoxide were added, so that the final molar ratio of EO and BO equals 3:3, continuously under stirring and cooling to keep the temperature of the reaction mixture at 115° C. and at an (absolute) internal reactor pressure of max. 3.0 bar over 3 minutes. After complete addition and an additional subsequent reaction time of four hours, the reactor was degassed again, the reaction mixture was cooled to 95° C., the reaction mixture was neutralized with H₃PO₄ (i.e., 30 wt. % of H₃PO₄ in water, based on the total mass of the solution), and 500 ppm of Anox 20 AM® based on the total mass of the composition were added. Water was removed by means of a vacuum distillation and precipitated salts were filtered off. 798.9 g of a yellow, clear polyether were thus obtained. The below reproduced structure PE2 of the polyether was determined by means of ¹H NMR, OH value, and iodine value determination. Thereby, PE2 is an average formula, in which the numbers of the repeating units each represent mean values averaged over all representatives of the compound. Moreover, although the repeating units are shown as blocks in PE2, the individual units are partially statistically distributed in the structure. During the last alkoxylation step a terminal BO unit is installed.

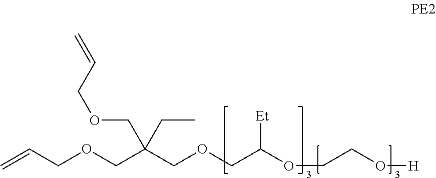

2. Preparation of Siloxane-Functional Compounds from the Obtained Polyethers

### 2.1 Siloxane Solution 1 (According to the Invention)

Into a 500 mL three-neck flask equipped with a KPG stirrer, a reflux condenser, and a dropping funnel, 113.3 g of the polyether PE1 were introduced and Pt in the form of a toluene solution of the Karstedt catalyst (w(Pt)=2%) in an amount of 15 ppm based on the total weight of the polyether and the heptamethyl trisiloxane was added. The mixture was heated to 80° C. Thereafter, 86.7 g of 1,1,1,3,5,5,5-heptamethyl trisiloxane (purity>99 wt.-%) were slowly added via the dropping funnel over a period of 30 minutes. An exothermic reaction was initiated. During the addition, the temperature rose to 102° C. at maximum. After completion of the addition, stirring was continued for 2 hours at 90° C. Then, the conversion of the SiH functionalities was determined volumetrically. For this purpose, a small sample of the reaction mixture was reacted with sodium butanolate solution (w(NaOBu)=5%) and the volume of the hydrogen formed was measured. The SiH conversion was 100%. A clear solution was obtained comprising a siloxane-functional compound (Siloxane 1) having the following general structure:

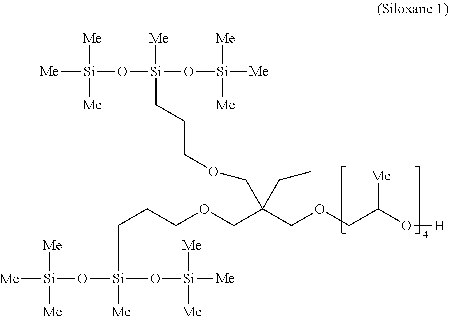

The obtained solution was blended as a 5 weight-% solution in a monofunctional polyether alcohol having a hydroxyl number of 84 mg KOH/g (Synalox 100-15B by Dow) and the resulting solution (Siloxane Solution 1) was used for foaming experiments.

### 2.2 Siloxane Solution 2 (According to the Invention)

Into a 500 mL three-neck flask equipped with a KPG stirrer, a reflux condenser, and a dropping funnel, 117.8 g of the polyether PE2 were introduced and Pt in the form of a toluene solution of the Karstedt catalyst (w(Pt)=2%) in an amount of 15 ppm based on the total weight of the polyether and the heptamethyl trisiloxane were added. The mixture was heated to 80° C. Thereafter, 60.0 g of 1,1,1,3,5,5,5-heptamethyl trisiloxane (purity>99%) were slowly added via the dropping funnel over a period of 30 minutes. An exothermic reaction was initiated. During the addition, the temperature rose to 100° C. at most. After completion of the addition, stirring was continued for 4 hours at 90° C. Then, the conversion of the SiH functions was determined volumetrically. For this purpose, a sample of the reaction mixture was reacted with sodium butanolate solution (w(NaOBu)=5%) and the volume of the hydrogen formed was measured. The SiH conversion was 99%. Thereafter, the reaction product was freed from slightly volatile components in vacuo (<1 mbar) at 130° C. A clear solution was obtained comprising a siloxane-functional compound (Siloxane 2) having the following general structure:

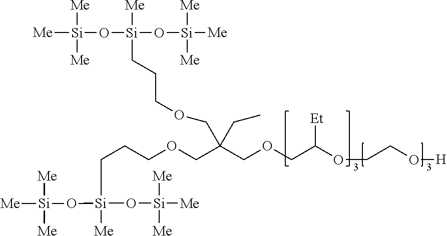

(Siloxane 2)

The obtained solution was blended as a 7 weight-% solution in a monofunctional polyether alcohol having a hydroxyl number of 84 mg KOH/g (Synalox 100-15B by Dow) and the resulting solution (Siloxane Solution 2) was used for foaming experiments.

### 2.3 Siloxane Solution 3 (not According to the Invention)

Into a 500 mL three-neck flask equipped with a KPG stirrer, a reflux condenser, and a dropping funnel, 80.6 g of the polyether PE3 were introduced and Pt in the form of a toluene solution of the Karstedt catalyst (w (Pt)=2%) in an amount of 15 ppm based on the total weight of the polyether and the heptamethyl trisiloxane were added. The mixture was heated to 80° C. Thereafter, 80.1 g of 1,1,1,3,5,5,5-heptamethyl-trisiloxane (purity>99) were slowly added via the dropping funnel over a period of 30 minutes. An exothermic reaction was initiated. During the addition, the temperature rose to 98° C. at most. After completion of the addition, stirring was continued for 90 minutes at 90° C. Then, the conversion of the SiH functions was determined volumetrically. For this purpose, a sample of the reaction mixture was reacted with sodium butanolate solution (w(NaOBu)=5%) and the volume of the hydrogen formed was measured. The SiH conversion was 100%. A clear solution was obtained comprising a siloxane-functional compound (Siloxane 3) having the following general structure:

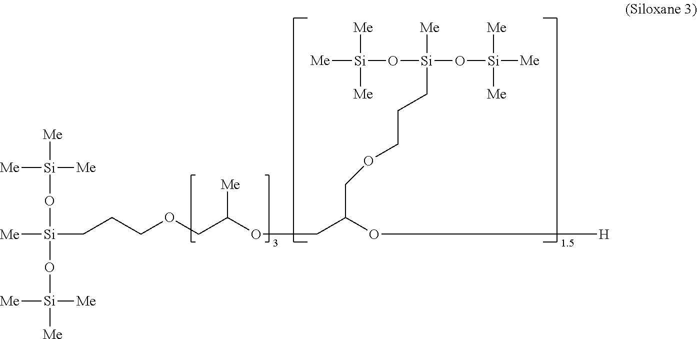

The obtained solution was blended as a 1 weight-% solution in a monofunctional polyether alcohol having a hydroxyl number of 84 mg KOH/g (Synalox 100-15B by Dow) and the resulting solution (Siloxane Solution 3) was used for foaming experiments.

### 3. Polyurethane Foams for Testing Physical Foam Characteristics (Formulation 1)

Polyurethane foams were prepared as so-called hand-mixed moulded foams in the laboratory according to Formulation 1 detailed below. The preparation of the foams was carried out according to the following specifications at 22±1° C. und 762 mm Hg air pressure. For the preparation of the foams, a heatable aluminium mould with the dimensions 40×40×10 cm was used. Prior to the preparation of the foam, the mould was treated with a solvent-based release agent.

The foams of Formulation 1 were used to determine the crushability (FTC analysis) and to analyse the skin and the peripheral zones.

Formulation 1 is described in the following Table 1. The amount of the respective stabilizer is described in Table 2 below.

TABLE 1

| Substance: | Amount: |
|---|---|
| DESMOPHEN ® 10 WF 15¹ | 100 pphp |
| DABCO ® TEOA² | 2.00 pphp |
| Water³ | 3.00 pphp |
| DABCO ® 33 LV⁴ | 0.60 pphp |
| TEGOAMIN ® DMEA⁵ | 0.20 pphp |
| Siloxane ⁶ and/or reference | x pphp |
| (TEGOSTAB ® B 8734 LF 2⁷) | (cf. Table 2) |
| Diisocyanate mixture MT 40-60⁸ | 46.2 pphp |

¹polyether triol (5000 g/mol) from Covestro
²triethanolamine
³demineralized water
⁴gel catalyst from Evonik ®
⁵amine catalyst from Evonik ®
⁶ used in the form of the aforementioned siloxane solutions, wherein the amount refers to the total siloxane solution (including the siloxane compound and the carrier solvent).
⁷foam stabilizer from Evonik ®
⁸mixture of 40% SUPRASECR 2447 (methylene diphenyl diisocyanate from Huntsman) and 60% DESMODUR ® T80 (Toluol diisocyanate T80 from Covestro), NCO = 41.3%, NCO index = 95

TABLE 2

| Example | Stabilizer |
|---|---|
| 1 (comparative) | No stabilizer |
| 2 (comparative) | 1 pphp of |
| | TEGOSTAB ® B 8734 LF 2 |
| 3 (inventive) | 0.4 pphp of siloxane solution 1 |
| 4 (inventive) | 0.5 pphp of siloxane solution 1 |
| 5 (inventive) | 0.3 pphp of siloxane solution 2 |
| 6 (inventive) | 0.7 pphp of siloxane solution 2 |
| 7 (inventive) | 1.0 pphp of siloxane solution 2 |
| 8 (inventive) | 0.3 pphp of siloxane solution 2 + |
| | 0.06 pphp of |
| | TEGOSTAB ® B 8734 LF 2 |
| 9 (inventive) | 0.7 pphp of siloxane solution 2 + 0.14 pphp |
| | TEGOSTAB ® B 8734 LF 2 |
| 10 (not inventive) | 0.5 pphp of siloxane solution 3 |
| 11 (not inventive) | 0.7 pphp of siloxane solution 3 |

For the preparation of the polyurethane foams, the polyol DESMOPHEN® 10WF15 was used in the relative amount specified in Table 1. The other components of the formulation were converted according to the proportions given in Tables 1 and 2, wherein, for example, 1.0 part (1.0 pphp) of a component means 1 g of this substance per 100 g of polyol. For the preparation of the foam, the polyol was contacted together with all other formulation components apart from the diisocyanate mixture with the respective siloxane solution and mixed for one minute with a paddle agitator at 1000 rpm to form a premix. Thereafter, the diisocyanate mixture was added to the premix within a few seconds and the mixture was stirred for 7 seconds at 2500 rpm. The polymerizing and foaming reaction mixture was transferred to an aluminium mould preheated to 40° C. within a few seconds and the mould was closed until demoulding. After 10 minutes the product was demoulded as a finished foam cushion.

Then, the foam body was compressed by force-to-crush measurements and manually crushed after the tenth measurement cycle as described hereinbelow. Then, the foam body was weighted and stored overnight. The skin quality was judged as described below. The foam cushion was cut approximately at ¼ of its length and the peripheral zone of the respective foam cushion was visually assessed as a whole and classified in excellent, good, fair, poor (severe defects). The cell count was conducted on the cut-edge-side of the foam.

### Measurement Methods for Characterizing Physical Foam Characteristics

### a) Number of Cells Per cm (Cell Count):

The number of cells is optically determined on a cut surface pursuant to the method set out in DIN EN 15702:2009-04.

### b) Force-to-Crush-Measurements

Force-to-crush (FTC) measurements were carried out using a universal testing machine of the type H10K-S by Tinius Olsen (manufacturer number: 672) with a maximum measurement of 10 kN. The measurements were carried out on the individual polyurethane foam pads as follows: Immediately after a foam pad has been demoulded (less than 15 seconds thereafter), the pad is placed in the start position of the FTC machine with the measuring foot/measuring plate/probe being 115 mm away from the bottom plate and in contact with the foam and moving at a rate of 500 mm/minute in the direction of the bottom plate. The initial foam thickness is measured when the force reaches 5 N. Without stopping at 5 N, the measuring foot continues to penetrate the foam at a rate of 500 mm/min until a distance of 50 mm to the bottom plate is reached. At this point, the force FTC1 is taken. There is no measurement interruption. The measuring foot returns at a rate of 500 mm/min to the start position, i.e., to a distance of 115 mm from the bottom plate, and thus ends the first cycle. Without any delay, 9 additional cycles are performed according to the same protocol than the first one (i.e., FTC2 to FTC10). After the 10th cycle, the measuring foot stops at the start position. Then, the foam pad is fully pressed manually by hand and again placed in the measurement position of the FTC machine. Another cycle (the 11th) is performed under the same conditions as the first ten cycles. The foam thickness at the end is now measured in the same way as the foam thickness at the beginning of the first cycle. Foam thickness at the beginning is judged by FTC1. The remaining closed-cell content is described by the difference FTC10-FTC11, and the crushability of the foam is read from the shape of the curve (how fast FTC falls). A steep decrease of the FTC values, especially between the first few cycles (FTC1-FTC2, FTC2-FTC3) refers to a high (good) crushability. The FTC11 value (i.e., the fresh foam hardness) can be used as a measure of foam cure.

### c) Skin Quality

The skin quality of the respective foam cushion was visually assessed as a whole and classified in excellent, good, fair, poor (severe defects).

### d) Quality of Peripheral Zone

The foam cushion was cut approximately at ¼ of its length and the peripheral zone of the respective foam cushion was visually assessed as a whole and classified in excellent, good, fair, poor (severe defects).

### Results

For testing the impact of the siloxanes on the press-on hardness (FTC measurement), the cell count, the weight of the foam, as well as the quality of the skin and the peripheral zone, polyurethane foam cushions according to Formulation 1 (see above) were prepared and analysed as detailed above. Results are shown in Table 3.

TABLE 3

| | | | | | | | | | Quality of |
|---|---|---|---|---|---|---|---|---|---|
| | | | | | | | | | the |
| | | FTC1 | FTC2 | FTC10 | FTC11 | Cell | Mass | Skin | peripheral |
| Example | Stabilizer | [N] | [N] | [N] | [N] | count | [g] | quality | zone |
| 1 | No stabilizer | 837 | 411 | 141 | 138 | 9 | 739 | good | poor to fair |
| (comparative) | | | | | | | | | |
| 2 | 1 pphp of | 1363 | 811 | 122 | 141 | 10.5 | 738 | good | excellent |
| (comparative) | TEGOSTAB ® | | | | | | | | |
| | B8734 LF 2 | | | | | | | | |
| 3 | 0.4 pphp of | 1232 | 885 | 165 | 138 | 10 | 736 | good | good |
| (inventive) | siloxane solution | | | | | | | | |
| | 1 | | | | | | | | |
| 4 | 0.5 pphp of | 1432 | 1079 | 181 | 129 | 10.5 | 738 | good | excellent |
| (inventive) | siloxane solution | | | | | | | | |
| | 1 | | | | | | | | |
| 5 | 0.3 pphp of | 1124 | 681 | 120 | 129 | 9.5 | 739 | good | fair |
| (inventive) | siloxane solution | | | | | | | | |
| | 2 | | | | | | | | |
| 6 | 10.7 pphp of | 1184 | 789 | 115 | 118 | 10 | 732 | good | good |
| (inventive) | siloxane solution | | | | | | | | |
| | 2 | | | | | | | | |
| 7 | 1.0 pphp of | 1313 | 906 | 126 | 121 | 10.5 | 746 | good | good |
| (inventive) | siloxane solution | | | | | | | | |
| | 2 | | | | | | | | |
| 8 | 0.3 pphp of | 1117 | 596 | 111 | 122 | 9 | 736 | good | good |
| (inventive) | siloxane solution | | | | | | | | |
| | 2 + 0.06 pphp of | | | | | | | | |
| | TEGOSTAB ® | | | | | | | | |
| | B8734 LF 2 | | | | | | | | |
| 9 | 0.7 pphp of | 1308 | 862 | 120 | 118 | 10 | 737 | good | excellent |
| (inventive) | siloxane solution | | | | | | | | |
| | 2 + 0.14 pphp | | | | | | | | |
| | TEGOSTAB ® | | | | | | | | |
| | B8734 LF 2 | | | | | | | | |
| 10 | 0.5 pphp of | 1226 | 777 | 127 | 132 | 10 | 742 | good | good |
| (not inventive) | siloxane solution | | | | | | | | |
| | 3 | | | | | | | | |
| 11 | 0.7 pphp of | 1332 | 934 | 156 | 132 | 10 | 742 | good | excellent |
| (not inventive) | siloxane solution | | | | | | | | |
| | 3 | | | | | | | | |

Example 1 corresponds to a foam without any stabilizer and serves as a comparative example. It has only a borderline low inherent stability (FTC1=837 N) and its peripheral zones exhibit subcutaneous defects. Additionally, a foam of comparative Example 2 was prepared as another reference by addition of the product TEGOSTAB® B 8734 LF 2 which is commonly utilized as stabilizer for moulded foams. The foam of comparative Example 2 has a sufficiently high stabilization (FTC1=1363 N) without tending to shrink when cooling down and additionally very well regulated or defect-free peripheral zones. The foams of Examples 3 to 7 applying the siloxane-functional compounds according to the invention of Siloxane Solutions 1 and 3 show that the use of siloxane-functional compounds according to the invention results in foams having similarly good material properties as the foam of comparative Example 2. For example, the value of the initially measured crush hardness FTC1 is in every example in the range of 1100-1350 N, FTC10 is always below 200 N and the final crush hardness after manual crushing FTC11 is just slightly below the one of comparative Example 2. The FTC data for the foams of Examples 3 to 9 illustrate a similarly good crushability compared to the foam of comparative Example 2. The peripheral zones are significantly improved compared to the foam of comparative Example 1 and in most cases regulated in an equally or similarly good manner as the foam of comparative Example 2 representing the ideal state by the use of TEGOSTAB® B 8734 LF 2. Moreover, the foams of Examples 8 and 9 demonstrate by means of the example of Siloxane Solution 2 according to the invention, that a combination of the siloxane-functional compounds according to the invention and a very low amount of the established stabilizer TEGOSTAB® B 8734 LF 2 results in excellent foams. These foams are characterized by a high inherent stability (FTC1=1117 N and 1308 N, respectively) and good or excellent peripheral properties. Further advantages of this combination compared to foams with a conventional stabilizer are demonstrated in the following by means of the emission profile of foams containing siloxane-functional compounds according to the invention with small amounts of the conventional stabilizer.

### 4. Polyurethane Foams for Testing Stabilizer-Related Foam Emissions (Formulation 2)

Polyurethane foams were prepared as so-called hand-mixed moulded foams in the laboratory according to Formulation 2 detailed below. The preparation of the foams was carried out according to the following specifications at 22±1° C. und 762 mm Hg air pressure. For the preparation of the foams, a heatable aluminium mould with the dimensions 40×40×10 cm was used. Prior to the preparation of the foam, the mould was treated with a solvent-based release agent.

The foams of Formulation 2 were used to determine the emission characteristics by thermal desorption analysis.

Formulation 2 is described in the following Table 4. The amount of the respective stabilizer is described in Table 4 below.

TABLE 4

| Substance | Amount |
|---|---|
| Arcol ® 1374¹ | 100 pphp |
| Voranol ® CP 1421² | 1.00 pphp |
| DABCO ® DEOA 85³ | 0.82 pphp |
| Water⁴ | 3.48 pphp |
| DABCO ® DMEA⁵ | 0.30 pphp |
| TEGOAMIN ® ZE 1⁶ | 0.60 pphp |
| Siloxane 1, 2, or 3⁷ and/or reference | x pphp |
| (TEGOSTAB ® B 8734 LF 2⁸) | (cf. Table 4) |
| Suprasec ® 2447⁹ | 57.8 pphp |

¹polyether triol (6000 g/mol) from Covestro
²cell opener from Dow
³curing agent from Evonik ®
⁴demineralized, chemical foaming agent
⁵blowing catalyst from Evonik ®
⁶amine-based catalyst from Evonik ®
⁷used in the form of the aforementioned siloxane solutions, wherein the amount refers to the total siloxane solution (including the siloxane compound and the carrier solvent).
⁸foam stabilizer from Evonik ®
⁹Methylene diphenyl diisocyanate from Huntsman, NCO index = 95

TABLE 5

| Example | Stabilizer |
|---|---|
| 12 (Comparative Example) | 1.0 pphp of TEGOSTAB ® B 8734 LF 2 |
| 13 (inventive) | 0.4 pphp of siloxane solution 1 |
| 14 (inventive) | 1.00 pphp of siloxane solution 2 |
| 15 (not inventive) | 1.00 pphp of siloxane solution 3 |
| 16 (not inventive) | 1.00 pphp of siloxane solution 2 + |
| | 0.2 pphp of TEGOSTAB ® B 8734 LF 2 |

For the preparation of the polyurethane foams, the polyol Arcol® 1374 was used in the relative amount specified in Table 4. The other components of the formulation were converted according to the proportions given in Tables 4 and 5, wherein, for example, 1.0 part (1.0 pphp) of a component means 1 g of this substance per 100 g of polyol. For the preparation of the corresponding foam, the polyol was contacted together with all other formulation components apart from the diisocyanate with the respective siloxane solution and mixed for one minute with a paddle agitator at 1000 rpm to form a premix. Thereafter, the diisocyanate was added to the premix within a few seconds and the mixture was stirred for 7 seconds at 2500 rpm. The polymerizing and foaming reaction mixture was transferred to an aluminium mould preheated to 55° C. within a few seconds and the mould was closed until demoulding. After 4 minutes, the product was demoulded as a finished foam cushion.

The thus obtained foam samples were submitted to thermal desorption analysis according to the following procedure for characterizing foam emissions.

### Thermal Desorption Analysis for Characterizing Foam Emissions

The polyurethane pads were characterized in terms of type and amount of the organic substances that can be outgassed from them. This was carried out using the VDA 278 standard (05/2016) of the German association of the automotive industry (“Verband der Automobilindustrie e.V.”, VDA) by means of thermal desorption analysis. By this analysis, two semi-quantitative sum values are determined which allow an estimation of the emission of slightly volatile organic compounds, i.e., the VOC value, and the proportion of condensable substances, i.e., the FOG value. In addition, individual substances of the emission are determined.

The thermal desorption analysis was carried out using a GC-MS device of the manufacturer Gerstel, Muhlheim an der Ruhr, Germany, of the type TDS-3 which was equipped with a KAS-4 injection system. Tenax® desorption tubes were used. Further, a gas chromatograph from Agilent Technologies, Santa Clara, USA, of the type 7890A as well as a mass spectrometer from Agilent Technologies of the type 5975C were utilized. An Agilent Technologies HP Ultra 2 was used as column having the dimensions 50 m (length), 0.32 mm (inner diameter), and 0.52 μm (film thickness). The carrier gas was helium.

The preparation of the samples and the thermal desorption analysis were carried out as follows: After the foams had been demoulded, they were stored for 24 hours at 21° C. and about 50% relative humidity. Thereafter, test specimens were taken evenly distributed over the width of the (cooled) moulded part at suitable and representative points. Afterwards, the samples were wrapped in an aluminium foil and sealed in a polyethylene bag.

From each foam sample, 10-15 mg balanced to the nearest 0.1 mg were placed centrally in the desorption tube. A helium stream was passed over the sample and the sample was heated to 90° C. for 30 minutes to cast out volatile organic compound referred to as VOC. The volatile substances (VOC) emitted during this process were directed by the inert gas stream into the cold trap of a temperature-programmable evaporator, which was cooled by liquid nitrogen, where they were trapped in a cooling trap. After completion of the bakeout phase, the cold trap was rapidly heated to 280° C. During this process, the focused substances were evaporated and separated by the gas chromatographic separation column and then detected by mass spectrometry. Thereafter, again a helium stream was passed over the sample and the sample was heated to 120° C. for 60 minutes to cast out even some semi-volatile compounds referred to as FOG. The FOG substances were also trapped in a cooling trap and furthermore analysed by GC according to the method described above for VOC. Calibration with reference substances allowed for a semi-quantitative estimate of the emission, expressed in “μg/g”. Toluene for the VOC analysis (VOC value) and n-hexadecane for the FOG value were used as reference substances. Based on their mass spectra and retention indices, signal peaks can be assigned to substances. The VOC value of detected VOC substances which were identified to comprise silicon is referred to as silicon-containing VOC (analogous for silicon-containing FOG).

### Results

Stabilizer-related emissions were analysed by thermal desorption analysis according to VDA 278 for foams according to Formulation 2 (see above) and employing the respective stabilizer set out in Table 5. Additionally, a foam according to Formulation 2 without addition of a stabilizer was prepared and used as a reference. The emissions of the stabilizer used in each case were determined by the difference of the value measured for the respective foam and the blank value for the reference foam without stabilizer; for example: VOC (stabilizer of the foam of Example 12)=VOC (foam of Example 12)−VOC (reference foam without stabilizer). The results are shown in Table 6.

TABLE 6

| | | | | Si- | Si- |
|---|---|---|---|---|---|
| | | | | con- | con- |
| | | | | taining | taining |
| | | VOC | FOG | VOC | FOG |
| Example | Stabilizer | [ppm] | [ppm] | [ppm] | [ppm] |
| 12 | 1.0 pphp of | 50 | 70 | 50 | 15 |
| (Comparative | TEGOSTAB ® | | | | |
| Example) | B 8734 LF 2 | | | | |
| 13 | 0.4 pphp of siloxane | 0 | 10 | 0 | 0 |
| (inventive) | solution 1 | | | | |
| 14 | 1.00 pphp of siloxane | 0 | 70 | 0 | 0 |
| (inventive) | solution 2 | | | | |
| 15 | 1.00 pphp of siloxane | 0 | 210 | 0 | 0 |
| (not inventive) | solution 3 | | | | |
| 16 | 1.00 pphp of siloxane | 10 | 80 | 10 | 0 |
| (inventive) | solution 2 + | | | | |
| | 0.2 pphp of | | | | |
| | TEGOSTAB ® B | | | | |
| | 8734 LF 2 | | | | |

The foam of Example 12, which was prepared utilizing the commonly applied stabilizer optimized for emission-sensitive applications, has an emission rate of 50 ppm VOC which entirely consists of silicone-containing compounds. The foams of Examples 13 to 14 applying the siloxane-functional compounds according to the present invention, however, do not show any emission within the measurement accuracy (VOC=0 ppm). The stabilizer-related fogging value (FOG value) for the foams of Examples 13 to 14 is 10, and 70 ppm, respectively. However, no silicone-containing compounds are detected, i.e., the VOC value and FOG value for Si-containing compounds is 0 ppm in each case. Thus, the siloxane-functional compounds according to the invention, i.e., Siloxane Solutions 1-2, do not show any silicone-containing emissions in the thermal desorption analysis in the tested amounts. Therefore, foams containing the stabilizers according to the invention are not only characterized by very good mechanical foam properties including very good peripheral zones, but also by excellent emission properties.

In the foam of Example 16, the Siloxane Solution 2 according to the invention was combined with a small amount of TEGOSTAB® B 8734 LF 2 which results in only very low silicone-containing VOC emissions of 10 ppm (reduction of 80% compared to the foam of Example 12). Si-containing FOG emissions are also 0 ppm for the foam of Example 16. Consequently, combinations of siloxane-functional compounds according to the invention with the aforementioned conventional stabilizer TEGOSTAB® B 8734 LF 2 do not only provide very good mechanical foam properties including very good peripheral zones, but also improved emission properties compared to the sole use of a conventional stabilizer.

1. A siloxane-functional compound, comprising:
at least two trisiloxane units bound to a polyether-functional backbone, wherein the siloxane-functional compound is represented by Formula (1); 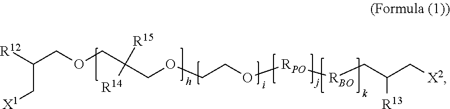
whereby
R_{PO}= 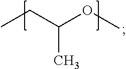
R_{BO}= 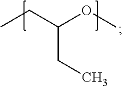
h=1 to 2;
i=0 to 20,
j=0 to 20,
k=0 to 20,
whereby the order of the units with indices h, I, j, and k in Formula (1) is arbitrary, and the units are in the form of blocks or statistically distributed in the structure of Formula (1);
R¹²=each individually selected from the group consisting of H and CH₃;
R¹³=each individually selected from the group consisting of H and CH₃;
R¹⁴=each individually selected from the group consisting of OH, hydrogen, CH₃, C₂H₅, CH₂OH, and CH₂—O—[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units are arranged blockwise or statistically distributed;
R¹⁵=each individually selected from the group consisting of hydrogen, CH₃, C₂H₅ and CH₂OH;
R¹⁶=each individually selected from the group consisting of hydrogen, CH₃, CH₂—CH₂—CH₂—X³ and CH₂—C(CH₃)H—CH₂—X⁴;
l=0 to 10,
m=0 to 10,
n=0 to 10,
whereby X¹, X², X³, and X⁴ each individually correspond to an alkyl trisiloxane unit.

2. The siloxane-functional compound according to claim 1, wherein
i=0;
j=0; and
k=0.

3. The siloxane-functional compound according to claim 1, wherein
h=1;
i=0;
j=0;
k=0;
R¹²=H;
R¹³=H;
R¹⁴=CH—O[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units are arranged blockwise or statistically distributed; 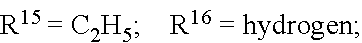
l=0 to 10,
m=0 to 10,
n=0 to 10,
whereby X¹, and X² each individually correspond to an alkyl trisiloxane unit.

4. The siloxane-functional compound according to claim 1, wherein
R¹⁴=CH—O[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units are arranged blockwise or statistically distributed;
l=0 to 10;
m=0 to 5;
n=0 to 10.

5. The siloxane-functional compound according to claim 1, wherein
R¹⁴=CH—O[CH₂—CH₂O]ₗ[CH₂—CH(CH₃)O]ₘ[CH₂—CH(C₂H₅)O]ₙ—R¹⁶; whereby the order of the units with indices l, m, and n in R¹⁴ is arbitrary and the units are arranged blockwise or statistically distributed;
l=1 to 5;
m=0 to 5;
n=1 to 5.

6. A siloxane composition, comprising:
one or more of the siloxane-functional compounds according to claim 1, and
optionally one or more further silicon-containing and/or silicon-free foam stabilizers.

7. The siloxane composition according to claim 6, wherein one or more trisiloxane unit(s) are replaced by tetrasiloxane unit(s), and wherein at least one of the tetrasiloxane units optionally comprises an octamethyl tetrasiloxane unit.

8. A composition for preparing a polyurethane foam, comprising:
a) at least one isocyanate-reactive compound having in average at least two groups per molecule being reactive to isocyanate groups;
b) at least one polyisocyanate having in average at least two isocyanate groups per molecule;
c) at least one blowing agent;
d) at least one catalyst;
e) at least one siloxane-functional compound according to claim 1; and
f) optionally one or more additives selected from the group consisting of dyes, pigments, fillers, antistatic additives, crosslinkers, chain extenders, cell openers, nucleating agents, thickeners, fragrances, cell expanders, plasticizers, hardening promoters, additives for preventing cold flow, aldehyde scavengers, additives for increasing resistance of polyurethane foams towards hydrolysis, compatibilizers (emulsifiers), adhesion promoters, and hydrophobization additives.

9. A method for preparing a polyurethane foam, comprising:
providing a composition comprising at least one isocyanate-reactive compound having in average at least two groups being reactive to isocyanate groups, at least one siloxane-functional compound according to claim 1, at least one blowing agent, at least one catalyst, and optionally one or more further additives;
contacting the composition with a polyisocyanate having in average at least two isocyanate groups per molecule or a mixture of polyisocyanates; and
curing the composition under formation of a polyurethane foam.

10. A polyurethane foam prepared in presence of at least one siloxane-functional compound according to claim 1.

11. The polyurethane foam according to claim 10, wherein the polyurethane foam exhibits one or both of
a silicon-containing volatile organic compounds (silicon-containing VOC) value determined according to VDA standard 278 of 10 ppm or less;
a proportion of condensable silicon-containing substances (Si-containing FOG value) determined according to VDA standard 278 of 10 ppm or less.

12. An article, comprising:
the polyurethane foam according to claim 10.

13. A method of preparing the siloxane-functional compound according to claim 1, the method comprising:
reacting a polyether comprising at least two carbon-carbon double bonds reactive to Si—H bonds with a hydrogen siloxane in presence of a catalyst suitable for hydrosilylation, whereby the hydrogen siloxane is a hydrogen trisiloxane, a hydrogen tetrasiloxane or a mixture thereof.

14. The method according to claim 13, wherein the hydrogen siloxane is 1,1,1,3,5,5,5-heptamethyltrisiloxane or 1,1,1,3,5,7,7,7-octamethyltrisiloxane, or mixtures thereof.

15. An additive in the production of a polyurethane foam, the additive comprising:
the siloxane-functional compound according to claim 1.
